(19) United States
(12) Patent Application Publication
(10) Pub. No.: US 2025/0001576 A1
(43) Pub. Date: Jan. 2, 2025

(54) WORKBENCH AND WORKBENCH MODULE

(71) Applicant: HANGZHOU GREAT STAR INDUSTRIAL CO., LTD., Hangzhou (CN)

(72) Inventor: Jingjian LI, Hangzhou (CN)

(21) Appl. No.: 18/786,498

(22) PCT Filed: Mar. 22, 2021
(86) PCT No.: PCT/CN2021/082055

§ 371 Date: Jul. 27, 2024

Related U.S. Application Data
(63) Continuation-in-part of application No. 17/299,756, filed on Jun. 3, 2021, now Pat. No. 12,076,848.

(51) Int. Cl. B25H 1/04; B25H 1/08

(52) U.S. Cl. CPC B25H 1/04; B25H 1/08

(57) ABSTRACT

A workbench and a workbench module are provided. The workbench includes an operating portion and a supporting portion, the operating portion includes at least one fitting member configured to be detachably connected to a fitted portion; when the workbench is at an accommodating state, the first supporting portion and the second supporting portion are folded up or stacked. A part of the operating portion can be in contact with a side of the first supporting portion, a part of the operating portion can be in contact with a side of the second supporting portion; or the operating portion can be in contact with a side of the first supporting portion or the second supporting portion.

### CROSS-REFERENCE TO RELATED APPLICATIONS

This application is a continuation in part of patent application Ser. No. 17/299,756, filed on Mar. 22, 2021, the patent application Ser. No. 17/299,756 is a National Stage application of international application No. PCT/CN2021/082055 filed on Mar. 22, 2021, and titled “WORKBENCH AND WORKBENCH MODULE”. The contents of the above identified applications are hereby incorporated herein in their entireties by reference.

### TECHNICAL FIELD

The present disclosure relates to the field of processing device, and in particular, to a workbench and a workbench module.

### BACKGROUND

The workbench usually requires some auxiliary tools to fit with each other to process external members during use. In order to facilitate operating, the auxiliary tools (such as clamp, grinding tools, electric tools, etc.) to be used are usually placed directly on the workbench. However, such a simple placement method can make the auxiliary tools to be easily moved, knocked over, or dropped out, resulting in damage to a workpiece or affecting processing progress. In addition, in related art, the workbench takes up a huge amount of space and is inconvenient to be accommodated when it is not in use.

### SUMMARY

According to various embodiments of the present disclosure, a workbench and a workbench module are provided.

The present disclosure provides a workbench. The workbench includes an operating portion configured for users to process an external object and a supporting structure configured to support the operating portion, wherein the operating portion includes at least one fitting member, the at least one fitting member is located on a periphery side of the operating portion and configured to be detachably connected to a fitted member. The supporting structure includes a first supporting portion and a second supporting portion connected to the operating portion. The workbench has an accommodating state, when the workbench is at the accommodating state, the first supporting portion and the second supporting portion are folded up or stacked in order. A part of the operating portion is capable of being in contact with a side of the first supporting portion, and a part of the operating portion is capable of being in contact with a side of the second supporting portion. The operating portion is capable of being in contact with a side of the first supporting portion. The operating portion is capable of being in contact with a side of the second supporting portion.

In some embodiments, the at least one fitting member and the operating portion are an integral structure or a separated structure.

In some embodiments, a side wall of the operating portion is provided with a mounting notch, and the at least one fitting member is detachably mounted on the mounting notch.

In some embodiments, the operating portion includes a bearing portion, the bearing portion is located on a side of the mounting notch towards a bottom wall of the operating portion and configured to limit the at least one fitting member.

In some embodiments, the at least one fitting member includes a first fitting portion, and the first fitting portion includes a snapping groove formed on a side of the operating portion.

In some embodiments, the operating portion includes an operation surface and a back surface separated from each other, and a side wall of the operating portion is formed between the operation surface of the operating portion and the back surface of the operating portion. The snapping groove is provided with a first groove opening located on the operation surface of the operating portion.

In some embodiments, the snapping groove is provided with a second groove opening in communication with the first groove opening, the second groove opening is formed on the side wall of the operating portion, and a size H2 of the second groove opening along a depth direction of the snapping groove is less than a depth H1 of the snapping groove.

In some embodiments, at least part of the snapping groove penetrates through the operating portion along a vertical direction of the workbench.

In some embodiments, along the vertical direction of the workbench, the snapping groove includes a first groove segment and a second groove segment in communication with each other, the second groove segment is formed on a bottom wall of the first groove segment, and the second groove segment penetrates through the operating portion.

In some embodiments, an inner sidewall of the snapping groove is provided with a plurality of limiting lock blocks protruding outwards, and the plurality of limiting lock blocks are arranged at intervals.

In some embodiments, the at least one fitting member includes a second fitting portion, and the second fitting portion includes a connecting protrusion disposed on and protruding out from a side wall or a top wall of the operating portion.

In some embodiments, the second fitting portion further includes a first adaptation groove and a second adaptation groove in communication with each other, a depth direction of the first adaptation groove and a depth direction of the second adaptation groove are both parallel to a protruding direction of the connecting protrusion, a length direction of the first adaptation groove is perpendicular to a length direction of the second adaptation groove, and the connecting protrusion is located on a communication position between the first adaptation groove and the second adaptation groove.

In some embodiments, the at least one fitting member includes a third fitting portion, the third fitting portion includes a first connecting groove where a depth direction of the first connecting groove is perpendicular to the side wall of the operating portion, a size of a bottom wall of the first connecting groove along the width direction a of the first connecting groove is greater than that of a groove opening of the first connecting groove along the width direction a of the first connecting groove, the first connecting groove is provided with a top groove opening, and a side of the first connecting groove away from the top groove opening is provided with a barrier block.

In some embodiments, the third fitting portion further includes a second connecting groove and a first protrusion, The first connecting groove is formed on a bottom wall of the second connecting groove. The first protrusion protrudes out from the bottom wall of the second connecting groove. The first protrusion includes a connecting portion and a convex portion. The connecting portion is connected to the bottom wall of the second connecting groove. The convex portion is connected to a side of the connecting portion away from the bottom wall of the second connecting groove. A size of the convex portion along the width direction a of the first connecting groove is greater than that of the connecting portion along the width direction a of the first connecting groove.

In some embodiments, the supporting portion is rotatably connected to the operating portion. The workbench further has a first working state and a second working state. The operating portion is capable of turning over relative to the supporting portion in order to switch between the first working state and the second working state.

The operating portion includes an operation surface and an auxiliary bearing surface. When the operating portion is at the first working state, the operation surface is defined as a work surface, and when the operating portion is at the second working state, the auxiliary bearing surface is defined as a work surface.

In some embodiments, the operating portion is in a plate shape, the operation surface and the supporting portion are located on two sides of the operating portion opposite to each other, and the auxiliary bearing surface is configured as a side surface of the operating portion and located between the operation surface and the supporting structure.

In some embodiments, the first supporting portion includes a third frame body. The second supporting portion includes a fourth frame body. The third frame body and the fourth frame body are hinged at two opposite ends of the operating portion. At least one of the third frame body and the fourth frame body is configured as a triangular support.

In some embodiments, the triangular support comprises a first supporting leg, a second supporting leg, a rotatable shaft, and a second fixing member. The first supporting leg and the second supporting leg are hinged on the operating portion by the rotatable shaft, respectively. The second supporting leg is connected between the first supporting leg and the second supporting leg. The second supporting leg, at least part of the first supporting leg, and at least part of the second supporting leg are formed a triangle.

In some embodiments, the first supporting leg is disposed towards the fourth frame body. The auxiliary bearing surface is disposed towards the second supporting leg. When the operating portion is at the second working state, the operating portion rotates towards the third frame body until being limited by the first supporting leg, and the auxiliary bearing surface turns over until being separated from the third frame body.

In some embodiments, the second fixing member is in a plate shape and capable of being folded, such that, when the workbench is at the accommodating state, the first supporting leg and the second supporting leg are in contact with each other.

The present disclosure further provides a workbench module. The workbench module includes at least one workbench and at least one fitted member. The fitted member includes a tool body and at least one adaptation portion. The adaptation portion is disposed on the tool body. The adaptation portion fits with at least part of the adaptation portion and is configured to detachably fit with the at least one fitting member of the workbench.

In some embodiments, the tool body is a hook. The hook includes a fastening portion and a hook portion. The hook portion is connected to the fastening portion. The adaptation portion is connected to a side of the fastening portion away from the hook portion.

In some embodiments, the tool body is an accommodating box, the accommodating box is provided with a cavity. The adaptation portion is connected to an outer periphery wall of the accommodating box.

In some embodiments, the tool body is a fixture, the fixture includes a rod, a movable fixture body and a fixed fixture body. The rod penetrates through the movable fixture body and the fixed fixture body. The adaptation portion is connected to a side of the fixed fixture body away from the movable fixture body.

In some embodiments, the adaptation portion protruding out from a side of the workbench is disposed on the side of the workbench.

In some embodiments, the fitted member comprises two adaptation portions. The tool body is a connecting member with a preset length. The two adaptation portions are disposed on two ends of the connecting member opposite to each other. The two fitting members are detachably connected to the fitting member of two workbenches or detachably mounted on adjacent two fitting members of one workbench after being folded.

### BRIEF DESCRIPTION OF THE DRAWINGS

FIG. 1 is a structural schematic diagram of a fixture of an embodiment of the present disclosure.

FIG. 2 is a structural schematic diagram of a workbench module in a first embodiment of the present disclosure.

FIG. 3 is a schematic diagram of the workbench in FIG. 2, wherein a part of the workbench is folded.

FIG. 4 is a schematic diagram of the workbench in FIG. 2, wherein the workbench is completely folded.

FIG. 5 is an assembly diagram of the workbench of the first embodiment in the present disclosure and four fixtures.

FIG. 6 is a cross-sectional view of the workbench of along A-A line in FIG. 5.

FIG. 7 is an enlarged view of A portion in FIG. 6.

FIG. 8 is a schematic diagram of the workbench module in the first embodiment of the present disclosure, which is used in a first scenario.

FIG. 9 is a schematic diagram of the workbench module in the first embodiment of the present disclosure, which is used in a second scenario.

FIG. 10 is a schematic diagram of the workbench module in the first embodiment of the present disclosure, which is used in a third scenario.

FIG. 11 is an enlarged view of B portion in FIG. 2.

FIG. 12 is an enlarged view of C portion in FIG. 4.

FIG. 13 is an enlarged view of D portion in FIG. 10.

FIG. 14 is a structural schematic diagram of the workbench module in FIG. 2 from another viewing angle.

FIG. 15 is an enlarged view of E portion in FIG. 14.

FIG. 16 is a schematic diagram of a first locking member in FIG. 15 in an opening state.

FIG. 17 is a structural schematic diagram of a fixing member.

FIG. 18 is a structural schematic diagram of a fixing member.

FIG. 19 is a structural schematic diagram of a workbench module in a second embodiment of the present disclosure.

FIG. 20 is a schematic diagram of the workbench module in the second embodiment of the present disclosure, which is used in a fourth scenario.

FIG. 21 is a schematic diagram of the workbench module in the second embodiment of the present disclosure, which is used in a fifth scenario.

FIG. 22 is a top view of the workbench module in FIG. 21.

FIG. 23 is a cross-sectional view of the workbench module in FIG. 22 along B-B line.

FIG. 24 is an enlarged view of F portion in FIG. 23.

FIG. 25 is a section view of the workbench module in FIG. 22 along C-C line.

FIG. 26 is an enlarged view of G portion in FIG. 25.

FIG. 27 is an enlarged view of H portion in FIG. 25.

FIG. 28 is a structural schematic diagram of a first accommodating groove in an embodiment of the present disclosure.

FIG. 29 is a structural schematic diagram of a first accommodating groove in another embodiment of the present disclosure.

FIG. 30 is a structural schematic diagram of a first accommodating groove in another embodiment of the present disclosure.

FIG. 31 is a structural schematic diagram of a first accommodating groove in another embodiment of the present disclosure.

FIG. 32 is a structural schematic diagram of a first accommodating groove in another embodiment of the present disclosure.

FIG. 33 is a structural schematic diagram of a first accommodating groove in another embodiment of the present disclosure.

FIG. 34 is an overall schematic diagram of a workbench of one embodiment in the present disclosure.

FIG. 35 is an enlarged schematic diagram of portion I of a first fitting portion in FIG. 34.

FIG. 36 is an enlarged schematic diagram of portion J of a second fitting portion in FIG. 34.

FIG. 37 is an overall schematic diagram of a fitted member of one embodiment in the present disclosure.

FIG. 38 is an overall schematic diagram of a fitted member of another embodiment in the present disclosure.

FIG. 39 is an overall schematic diagram of a fitted member of another embodiment in the present disclosure.

FIG. 40 is an overall schematic diagram of a fitted member of another embodiment in the present disclosure.

FIG. 41 is an overall schematic diagram of a fitted member of another embodiment in the present disclosure.

FIG. 42 is an enlarged schematic diagram of portion K in FIG. 41.

FIG. 43 is an overall schematic diagram of a workbench module of one embodiment in the present disclosure.

FIG. 44 is an overall schematic diagram of a workbench module of one embodiment in the present disclosure.

FIG. 45 is an enlarged schematic diagram of portion L in FIG. 44.

FIG. 46 is an overall schematic diagram of a workbench of one embodiment in the present disclosure.

FIG. 47 is an enlarged schematic diagram of a third fitting portion of portion M in FIG. 46.

FIG. 48 is a top view of a workbench of one embodiment in the present disclosure.

FIG. 49 is an overall schematic diagram of a fitted member of one embodiment in the present disclosure.

FIG. 50 is an overall schematic diagram of a fitted member of another embodiment in the present disclosure.

FIG. 51 is an overall schematic diagram of a fitted member of another embodiment in the present disclosure.

FIG. 52 is an overall schematic diagram of a fitted member of another embodiment in the present disclosure.

FIG. 53 is an overall schematic diagram of a workbench module of one embodiment in the present disclosure.

FIG. 54 is an overall schematic diagram of a fitted member of one embodiment in the present disclosure.

FIG. 55 is an overall schematic diagram of a workbench module of one embodiment in the present disclosure.

FIG. 56 is an enlarged schematic diagram of portion N in FIG. 55.

FIG. 57 is a schematic diagram of a workbench of a first working state in a first view of one embodiment in the present disclosure.

FIG. 58 is a schematic diagram of the workbench of a first working state in a second view of one embodiment in the present disclosure.

FIG. 59 is a schematic diagram of the workbench of a first working state in a third view of one embodiment in the present disclosure.

FIG. 60 is a top view of a workbench module of one embodiment in the present disclosure.

FIG. 61 is a front view of a workbench of one embodiment in the present disclosure.

FIG. 62 is a schematic diagram of a workbench at a second working state of one embodiment in the present disclosure.

FIG. 63 is a schematic diagram of a workbench at an accommodating state of one embodiment in the present disclosure.

In the figures, 100 represents a workbench; 10 represents an operating portion; 101 represents first folding portion; 1011 represent a second groove; 102 represents a second folding portion; 103 represents a fixing portion; 104 represents an operation surface; 105 represents a back surface; 1051 represents a second accommodating groove; 106 represents a first groove; 107 represents a auxiliary bearing surface; 1071 represents a fixing position; 11 represents an first accommodating groove; 120 represents a side wall; 1201 represents a fitting member; 1202 represents a bearing portion; a represents a width direction; 1203 represents a mounting notch; 1211 represents a first fitting portion; 12110 represents a snapping groove; 12111 represents a first groove opening; 12112 represents a second groove opening; 12113 represents a first groove segment; 12114 represents a second groove segment; 12115 represents a limiting lock block; 1212 represents a second fitting portion; 12121 represents a connecting protrusion; 12122 represents a first adaptation groove; 12123 represents a second adaptation groove; 1213 represents a third fitting portion; 12131 represents a first connecting groove; 12001 represents a third groove opening; 12002 represents a top groove; 12132 represents a second connecting groove; 12003 represents a bottom wall; 12133 represents a first protrusion; 12004 represents a connecting portion; 12005 represents a convex portion; 1214 represents a barrier block; 140 represents a spacing; 12 represents a first locating portion; 121 represents a locating pin; 122 represents a first elastic member; 123 represents a limiting sheet; 124 represents an operation member; 13 represents a first mounting hole; 14 represents a second mounting hole; 15 represents a third mounting hole; 171 represents a first pressing member; 1711 represents a connecting member; 172 represents a second pressing member; 1721 represents a locating column; 173 represents a third elastic member; 174 represents a mounting gap; 18 represents an arc-shaped groove; 20 represents a supporting structure; 201 represents a first supporting portion; 202 represents a second supporting portion; 21 represents a first frame body; 211 represents a mounting frame; 212 represents a supporting rod; 2121 represents an outer rod; 2122 represents an inner rod; 21221 represents a locking hole; 21222 represents a mat; 213 represents a connecting rod; 2131 represents an accommodating hole; 2132 represents a chute; 214 represents a hook portion; 215 represents a second locking member; 2151 represents a second locking portion; 2152 represents a pushing portion; 216 represents a second elastic member; 22 represents a second frame body; 23 represents a first foldable plate; 231 represents an axle pin plate; 2311 represents a pin axle; 2312 represents a limiting member; 232 represents an axle sleeve plate; 2321 represents an axle sleeve; 2322 represents a limiting hole; 233 represents a peripheral plate; 2331 represents a stopper; 2332 represents a limiting groove; 24 represents a second foldable plate; 25 represents a third frame body; 251 represents a first supporting leg; 252 represents a second supporting leg; 253 represents a rotatable shaft; 254 represents a second fixing member; 254a represents a first fixing plate; 254b represents a second fixing plate; 26 represents a fourth frame body; 30 represents a supporting member; 31 represents a middle section; 40 represents a first locking member; 41 represents a mounting portion; 42 represents a first locking portion; 50 represents a first fixing member; 51 represents a third clamping surface; 52 represents a mounting member; 2000 represents a workbench module; 200 represents a fitted member; 2100 represents a tool body; 211 represents a hook; 2111 represents a fastening portion; 2112 represents a hook portion; 212 represents an accommodating box; 2121 represents a cavity; 213 represents a connecting member; 210 represents a fixture; 2110 represents a rod; 21101 represents a locating hole; 2120 represents a fixed fixture body; 21201 represents a first clamping surface; 2130 represents a movable fixture body; 21301 represents a second clamping surface; 2200 represents an adaptation portion; 300 represents an external object; and 310 represents a stacking box.

### DETAILED DESCRIPTION

The following will provide a clear and complete description of the technical solution in the embodiments of the present disclosure, in communication with the accompanying drawings. Obviously, the described embodiments are only a part of the embodiments of the present disclosure, not all of them. Based on the embodiments in the present disclosure, all other embodiments obtained by ordinary skill in this art without creative labor fall within the scope of protection of the present disclosure.

It should be noted that, when a member is considered “connected to” another member, it can be directly fixed to another member or there may be a centered member present simultaneously. When a member is considered “set on” another member, it can be directly set on another member or there may be a centered member present simultaneously. When a member is considered “fixed to” another member, it can be directly fixed to another member or there may be a centered member present simultaneously.

Unless otherwise defined, all technical and scientific terms used in this article have the same meanings as those commonly understood by those skilled in the technical field of the present disclosure. The terms used in the specification of the present disclosure are only for the purpose of describing specific embodiments and are not intended to limit the present disclosure. The term “or/and” used in this article includes any and all combinations of one or more related listed items.

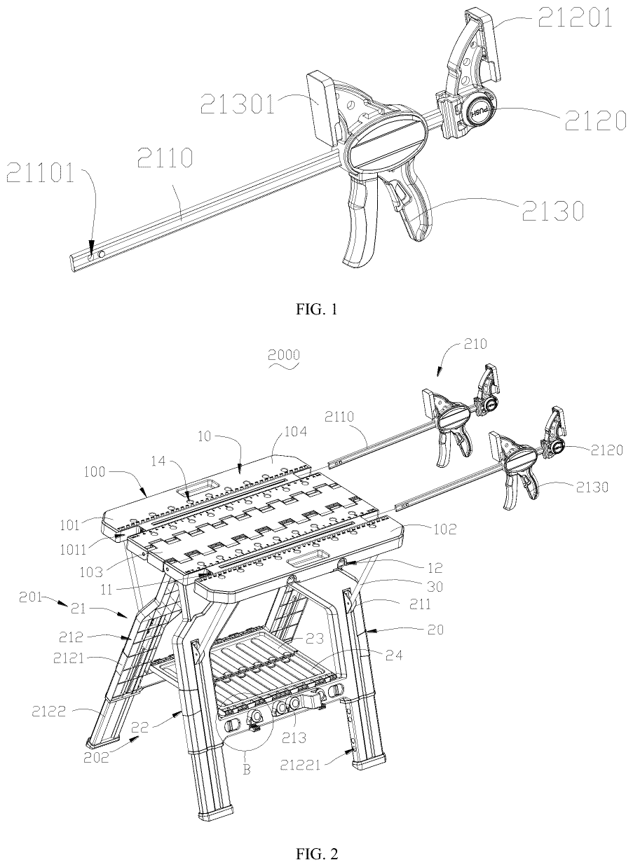

Referring to FIG. 1 and FIG. 2, the present disclosure provides a workbench module 2000 and a workbench 100. The workbench module 2000 can include the workbench 100 and a fixture 210. The workbench module 2000 can be configured for fixing an external object 300 and facilitating to process the external object. In the present embodiment, the workbench module 2000 can be used in a field of woodworking. It should be understood that in other embodiments, the workbench module 2000 can further be used in other workplaces needing to clamp an object, such as family, industry and the like.

FIG. 1 is a structural schematic diagram of a fixture 210 in an embodiment of the present disclosure. The fixture 210 can include a rod 2110, a fixed fixture body 2120 and a movable fixture body 2130. At least one locating hole 21101 is located on the rod 2110. The fixed fixture body 2120 is fixed to the rod 2110 via the locating hole 21101, and the movable fixture body 2130 can be sleeved on the rod 2110 and move along the rod 2110 under driven by a user. The fixed fixture body 2120 can include a first clamping surface 21201, and the movable fixture body 2130 can include a second clamping surface 21301. The first clamping surface 21201 and the second clamping surface 21301 can cooperate with each other to clamp the external object 300.

In some embodiments, the locating hole 21101 can be located on both ends of the rod 2110, to improve applicability of the fixture 210. Furthermore, the fixed fixture body 2120 can be detachably disposed on the locating hole 21101.

Furthermore, the movable fixture body 2130 can include a third pressing member (not shown in the figures) and a fourth pressing member (not shown in the figures). When the user presses the third pressing member, the movable fixture body 2130 can reciprocate along the rod 2110. When the user presses the fourth pressing member, the movable fixture body 2130 can apply a clamp force to an object to be clamped. A locking device (not shown in the figures) can be configured for remaining the fixture in a clamping state. After using, the user can press the third pressing member again to release the clamping state. It should be understood that the fixture 210 of the present disclosure can be other conventional fixtures 210, which will not be described in detail herein.

In some embodiments, the fixture 210 in the present disclosure can be an F-shaped fixture.

In conventional art, when the workbench cooperates with the fixture, a T-shaped chute is located on an operating surface of the workbench to fix the movable fixture body of the fixture to one side of the workbench. The fixed fixture body and the rod can slide in the chute, thereby clamping the external object (e.g., a structure shown in Chinese patent No. CN104249315B). However, when a force applied on the fixture is uneven, the rod is prone to roll over around the movable fixture body as a rotation center, resulting in the rod separating from the chute. Moreover, the rod of the fixture is exposed to the outside, which is susceptible to friction from the objects to be processed such as wood, affecting the service life of the fixture. During use, the rod moving relative to the workbench will bring safety hazards. When using the workbench, the user should continuously pay attention to avoiding collisions of the rod, which will affect the clamping efficiency.

Referring to FIG. 2, and referring to FIG. 8 to FIG. 10. FIG. 2 is a structural schematic diagram of a workbench module 2000 in a first embodiment of the present disclosure. FIG. 8 to FIG. 10 are schematic diagrams of the workbench module 2000 in the first embodiment of the present disclosure, which are being used in different scenarios.

In the present disclosure, the workbench 100 can include an operating portion being configured for a user to process an external object 300, wherein the operating portion 10 can include a first accommodating groove 11. The rod 2110 of the fixture 210 can insert into the first accommodating groove 11. The first accommodating groove 11 can be configured for detachably fixing the rod 2110 of the fixture 210. The workbench 100 and the movable fixture body 2130 of the fixture 210 can cooperate with each other to clamp the external object 300. Alternatively, two movable fixture bodies 2130 of two fixtures 210 can cooperate with each other to clamp the external object 300. Therefore, the workbench 100 can detachably dispose the rod 2110 of the fixture 210 in the first accommodating groove 11, thereby improving stability of the fixture 210 and preventing rollover of the fixture 210 during use. Moreover, since the rod 2110 is fixed to the workbench 100, safety hazards caused by moving the rod 2110 can be reduced. In addition, the user can clamp the external object 300 conveniently by merely handling the movable fixture body 2130 of the fixture 210.

In the present disclosure, the workbench 100 can be a carpenter's workbench, a sawhorse, and the like.

In some embodiments, a second groove 1011 of the movable fixture body 2130 can be located on a sidewall of the operating portion 10. The second groove 1011 not only can be configured for preventing the fixture 210 excessively protruding out from the workbench module 2000 and influencing operation of the user, but also can be configured for limiting the movable fixture body 2130 and avoiding movement of the movable fixture body 2130. It should be understood that in some embodiments (not shown in the present disclosure), if not considering influence caused by the movable fixture body 2130 protruding out from the operating portion 10, the operating portion 10 can be provided without the second groove 1011, and the movable fixture body 2130 can protrude out from the operating portion 10 after assembly.

The operating portion 10 can include an operating surface 104 configured for placing the external object 300. A distance can be defined between a side near the operating surface 104 of the first accommodating groove 11 and the operating surface 104. That is, the first accommodating groove 11 can be located inside the operating portion 10, and a peripheral wall of the first accommodating groove 11 can protect the rod 2110 from exposing to the outside, thereby preventing the external object 300 from contacting and damaging the rod 2110.

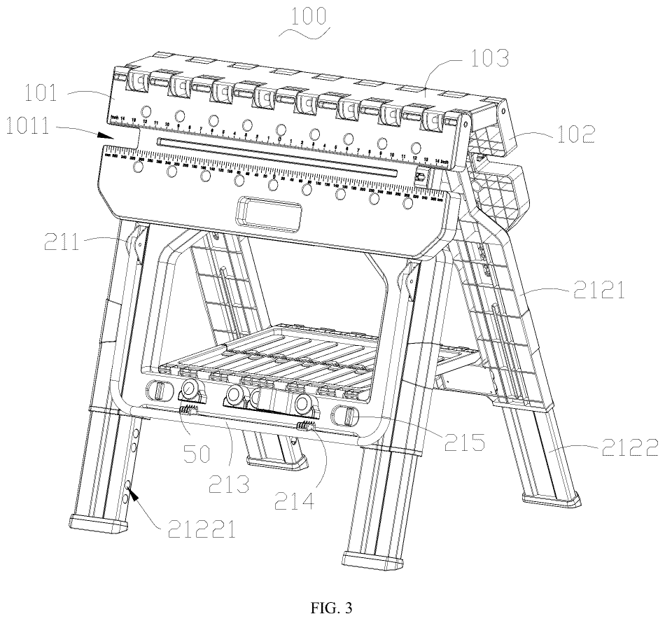

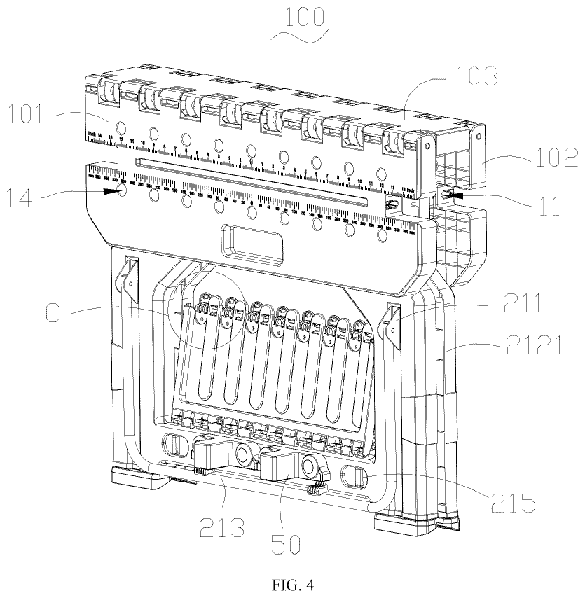

In some embodiments, referring to FIG. 3 and FIG. 4, the workbench 100 further includes a supporting structure 20, the supporting structure 20 is configured to support the operating portion 10. The operating portion 10 can include a folding portion (not labelled) and a fixing portion 103. The folding portion can be rotatably connected to the fixing portion 103, and the folding portion can be folded relative to the fixing portion 103 and accommodated. The fixing portion 103 can be connected to the supporting structure 20, which is configured for supporting the operating portion 10 via the fixing portion 103. When the user needs a larger operating portion 10, the folding portion can be rotated and transformed to an expanding state. When the user wants to accommodate the workbench 100, the folding portion can be rotated relative to the fixing portion 103 and transformed to a folding state, to reduce space occupied by the workbench 100.

Furthermore, the folding portion can further include a first folding portion 101 and a second folding portion 102. The first folding portion 101 and the second folding portion 102 can be disposed at two sides of the fixing portion 103, respectively, and able to fold relative to the fixing portion 103, respectively. Due to the design of the first folding portion 101 and the second folding portion 102, the operating portion 10 can be used in more situations. The operating portion 10 in the expanding state can have a larger area, and the operating portion 10 in the folding state can occupy smaller storage space.

Furthermore, in the first embodiment, the operating portion 10 can include two first accommodating grooves 11. The two first accommodating grooves 11 can be located in the first folding portion 101 and the second folding portion 102, respectively. The first accommodating groove can penetrate through two sides of the first folding portion 101 or the second folding portion 102 separated from each other, so that the fixture 210 can insert into the first accommodating groove 11 from different positions of the operating portion 10. Therefore, the workbench module 2000 can be used in more situations. In some embodiments, a plurality of first accommodating grooves 11 can further be located on the first folding portion 101 and/or the second folding portion 102, which are not limited herein.

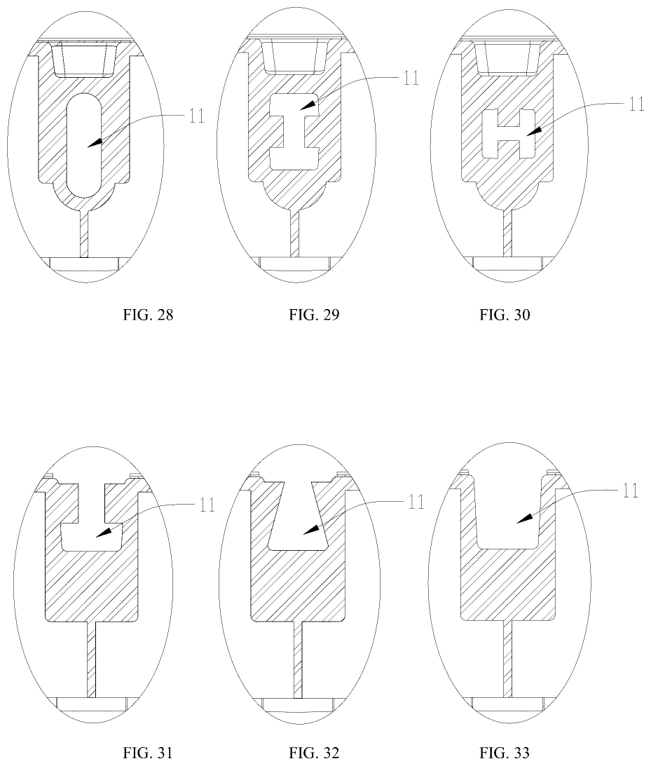

It should be noted that the first accommodating groove 11 can be a closed through hole as shown in FIG. 28 to FIG. 30. Alternatively, the first accommodating groove 11 can be an opening groove as shown in FIG. 31 to FIG. 33. From the perspective of a shape of a cross-section of the groove, the first accommodating groove 11 should be able to let the rod 2110 insert in and be fixed. The cross-section of the first accommodating groove 11 can be strip-shaped (as shown in FIG. 28), “I”-shaped (as shown in FIG. 29 to FIG. 31), trapezoid-shaped (as shown in FIG. 32) and the like. It should be understood that all the first accommodating grooves 11 above can improve stability of the rod 2110 in the first accommodating groove 11, so that the rod 2110 can be hard to separate from the first accommodating groove 11. In some embodiments, in order to facilitate the user placing the rod 2110 into the first accommodating groove 11, the first accommodating groove 11 can be U-shaped (as shown in FIG. 32), or in other shapes facilitating placing the rod 2110, which are not limited in the present disclosure.

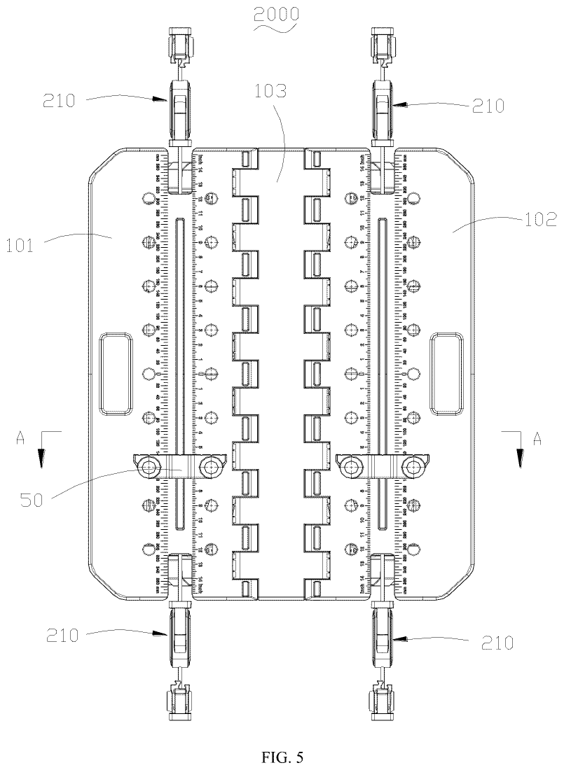

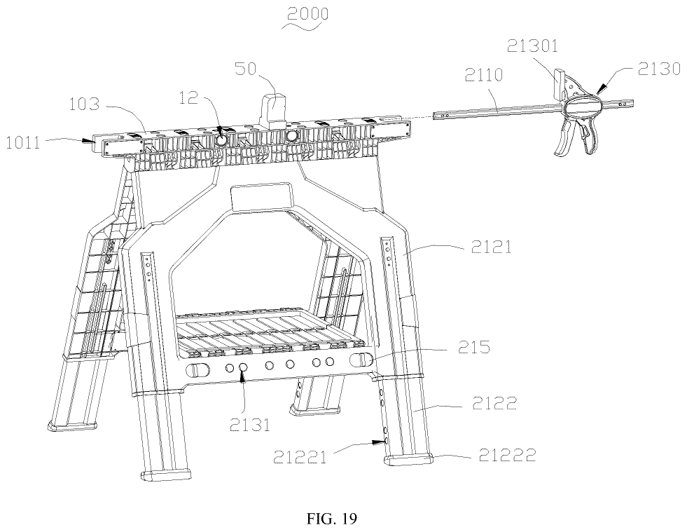

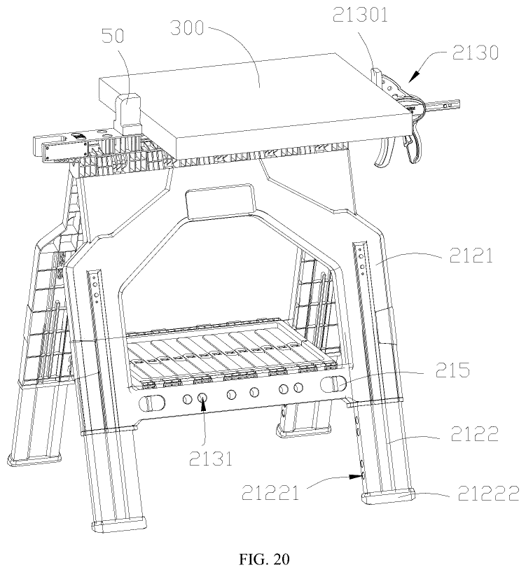

It should be understood that the workbench 100 can cooperate with a plurality of fixtures 210 at the same time, and the plurality of fixtures 210 can cooperate with each other. Therefore, the workbench module 2000 can be used in more situations, and clamp the external object 300 more firmly (as shown in FIG. 5). Moreover, in other embodiments, for example in a second embodiment as shown in FIG. 19 to FIG. 21, the first accommodating groove 11 can be located on the fixing portion 103 and the workbench 100 can be provided without the folding portion.

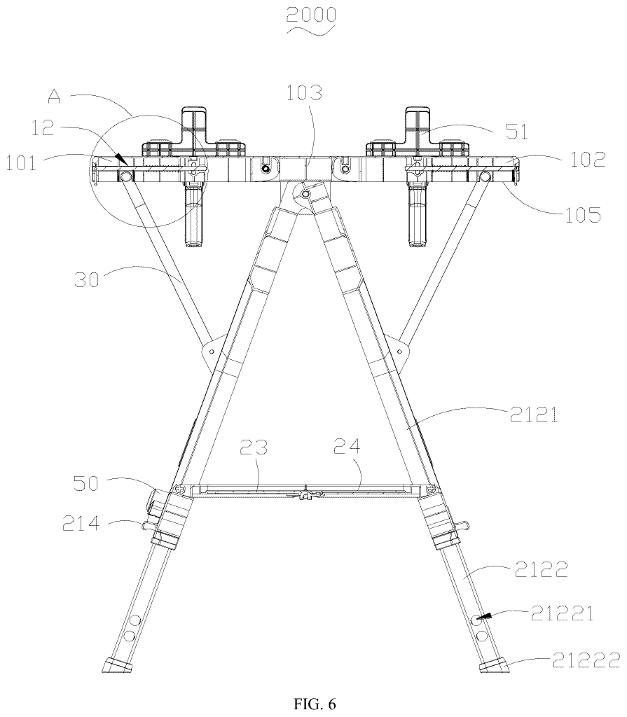

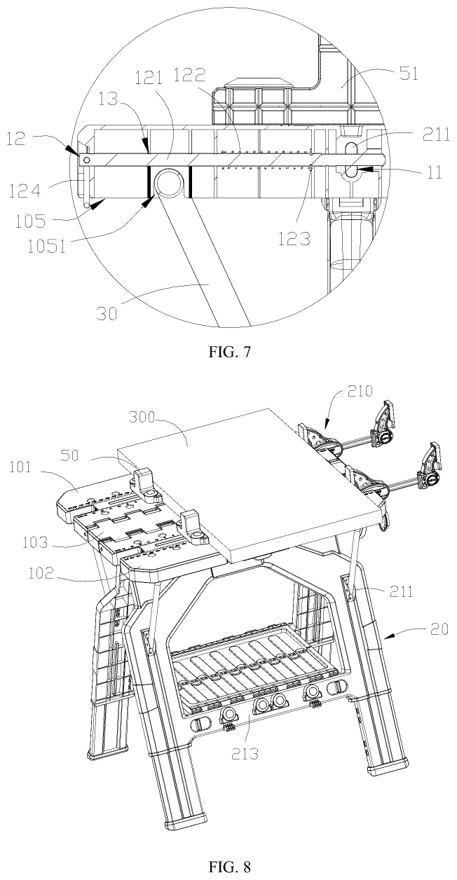

Referring to FIG. 6 to FIG. 7, the workbench 100 can include a first locating portion 12, which can insert into the first accommodating groove 11 and be configured for limiting the rod 2110 to move within the first accommodating groove 11.

It should be understood that in other embodiments a pin (not shown in the figures) on the rod 2110 can be used to locate the rod 2110 and prevent the rod 2110 from moving in the first accommodating groove 11, as long as the rod 2110 can be detachably fixed in the first accommodating groove 11.

In some embodiments, the workbench 100 can include a first mounting hole 13 penetrating through the first accommodating groove 11. The first locating portion 12 can include a locating pin 121, which can be able to move in the first mounting hole 13 and insert into a locating hole 21101 of the rod 2110, resulting in the rod 2110 detachably fixing in the first accommodating groove 11. That detachably disposing the rod 2110 in the first accommodating groove 11 via the locating pin 121 can be easy to operate. Moreover, the rod 2110 can be fixed by the locating hole 21101 in the fixture 210, resulting in that the workbench 100 can cooperate with the conventional fixture. Therefore, the workbench 100 can be used in more situations. It should be understood that the first locating portion 12 can be disposed on the workbench 100 via other structures such as a mounting groove and the like, which are not limited in the present disclosure.

Furthermore, the first locating portion 12 further can include a first elastic member 122, which can be configured for applying an elastic force on the locating pin 121, resulting in the locating pin 121 extending into and remaining in the locating hole 21101, thereby preventing the rod 2110 from moving in the first accommodating groove 11.

In order to facilitate the first elastic member 122 applying an elastic force on the locating pin 121, the first locating portion 12 can further include a limiting sheet 123. The limiting sheet 123 can be sleeved on and fixed to the locating pin 121. The first elastic member 122 can be sleeved on the locating pin 121, and two ends of the first elastic member 122 can abut against the limiting sheet 123 and the operating portion 10, respectively, so that the first elastic member 122 can be configured for applying an elastic force on the locating pin 121 via the limiting sheet 123.

In order to facilitate processing, in the present disclosure, the limiting sheet 123 and the locating pin 121 can be formed integrally. It should be understood that the limiting sheet 123 and the locating pin 121 can be formed separately and fixed together.

In some embodiments, a back surface 105 of the operating portion 10 can include net-shaped reinforcing plates. The first elastic member 122 can abut against the net-shaped reinforcing plates of the back surface 105, as shown FIG. 7. The net-shaped reinforcing plates not only can reduce the weight of the workbench 100, but also can improve strength of the workbench 100 and prevent the workbench 100 from deforming during processing. Meanwhile, the net-shaped reinforcing plates can facilitate assembling elements on the operating portion 10, and facilitate disposing and reconditioning the first elastic member 122. It should be understood that the back surface 105 of the operating portion 10 is not limited to the net-shaped reinforcing plate, other structures (e.g., a flap) can also be disposed on the operating portion 10, so that the first elastic member 122 can abut against the flap.

For convenience of the user, the first locating portion 12 can further include an operating member 124. The operating member 124 can be movably connected to an end away from the first accommodating groove 11 of the locating pin 121. The operating member 124 can be configured for the user to draw the locating pin 121. In some embodiments, the operating member 124 can be circle-shaped, which is not easy to hurt the user. Moreover, the operating member 124 can naturally hang down on a side of the operating portion 10 when the user is not using the workbench 100, so as to facilitate accommodating and using the workbench 100.

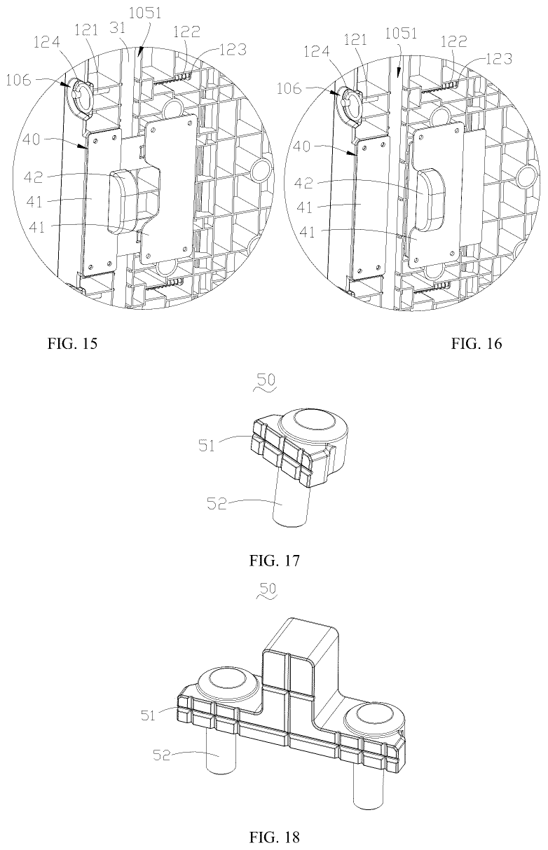

Furthermore, in order to protect the operating member 124 and facilitate accommodating the operating member 124, a first groove 106 can be located on a sidewall of the workbench 100, and the first groove 106 is configured for accommodating the operating member 124 (as shown in FIG. 15 and FIG. 16).

Moreover, in order to facilitate accommodating the workbench 100, the supporting structure 20 includes a first supporting portion 201 and a second supporting portion 202 both connected to the operating portion 10. The workbench 100 has an accommodating state, when the workbench 100 is at the accommodating state, the first supporting portion 201 and the second supporting portion 202 are folded up or stacked in order. In particular, a part of the operating portion 10 can be in contact with a side of the first supporting portion 201, a part of the operating portion 10 can be in contact with a side of the second supporting portion 202. Alternatively, the operating portion 10 can be in contact with the side of the first supporting portion 201. Alternatively, the operating portion 10 can be in contact with the side of the second supporting portion 202.

A method of the operating portion 10 abutting against the first supporting portion 201 or the second supporting portion 202 can be that the operating portion 10 rotates relative to the first supporting portion 201 and/or the second supporting portion 202; or, the first supporting portion 201 and/or the second supporting portion 202 rotates relative to the operating portion 10. It is not limited herein.

In some embodiments, when the operating portion 100 is at the accommodating state, the first supporting portion 201 moves towards the second supporting portion 202. A part of the operating portion 10 rotates and is in contact with the side of the first supporting portion 201, and a part of the operating portion 10 rotates and is in contact with the side of the second supporting portion 202.

Referring to FIG. 2 to FIG. 4 and FIG. 8 to FIG. 10, for example, in one embodiment, the first supporting portion 201 can include a first frame body 21, and the second supporting portion 202 includes a second frame body 22, and both the first frame body 21 and the second frame body 22 can be rotatably connected to the operating portion 10. The first frame body 21 can rotate and move away from the second frame body 22, and the second frame body 22 can rotate and move away from the first frame body 21. At this time, the first frame body 21 and the second frame body 22 can form a supporting state. In the supporting state, the first frame body 21 and the second frame body 22 can support the workbench 100 to make the workbench stand on the ground. The first frame body 21 can rotate and move towards the second frame body 22, and the second frame body 22 can rotate and move towards the first frame body 21. At this time, the first frame body 21 and the second frame body 22 can stacked in order to form an accommodating state, so as to reduce the space occupied by the supporting structure 20, which is conducive to storage of the operating portion. In other words, the supporting structure 20 can open to form the supporting state or be folded to form the accommodating state.

In some embodiments, both the first frame body 21 and the second frame body 22 can include two supporting rods 212 and a connecting rod 213. The connecting rod 213 can be configured for connecting the two supporting rods 212 to increase mechanical strength of the first frame body 21 and the second frame body 22 and prevent the first frame body 21 and the second frame body 22 from deforming. It should be understood that the first frame body 21 and/or the second frame body 22 can be provided without the connecting rod 213. The first frame body 21 and/or the second frame body 22 without the connecting rod 213 can also support the workbench 100.

In the present embodiment, referring to FIG. 14, the supporting member 30 can be a U-shaped rod, and two ends of the U-shaped rod can be pivotally connected to the two supporting rods 212 of the first frame body 21 or two supporting rods 212 of the second frame body 22. A middle section 31 of the U-shaped rod can be configured for contacting with and supporting the first folding portion 101 and the second folding portion 102 to remain the first folding portion 101 or the second folding portion 102 in the expanding state. The middle section 31 of the U-shaped rod can be configured for supporting the first folding portion 101 and the second folding portion 102, and can have relatively good supporting effect. In some embodiments, the supporting member 30 can have other shapes. In some embodiments, a plurality of supporting members 30 can be disposed on the first frame body 21 or the second frame body 22. For example, two T-shaped rods can be rotatably connected to the two supporting rods 212 of the first frame body 21 or the two supporting rods 212 of the second frame body 22. A cross-rod of the T-shaped rod can be configured for supporting the first folding portion 101 and the second folding portion 102.

In the present embodiment, the connecting rod 213 can include a hook portion 214, and the hook portion 214 can be configured for clipping the middle section 31 of the U-shaped rod to prevent the supporting member 30 from rotating towards a direction away from the connecting rod 213. Therefore, the supporting member 30 will not move from back to forth during storing and transporting the workbench 100, and this can facilitate storing the workbench 100. It should be understood that in other embodiments, the hook portion 214 can further be disposed on the supporting rod 212, as long as the hook portion 214 can be configured for clipping the supporting member 30. Moreover, the supporting member 30 can be disposed at different positions of the hook portion 214 according to a shape of the supporting member 30.

The hook portion 214 and the connecting rod 213 can be formed integrally, or can be formed separately and then fixed together. Alternatively, the hook portion 214 can be detachably connected to the connecting rod 213, resulting in the hook portion 214 disposing at different positions of the connecting rod 213.

In some embodiments, the workbench 100 can further include two supporting members 30. The two supporting members 30 can be rotatably connected to the supporting structure 20, and the two supporting members 30 can be configured for supporting the first folding portion 101 and the second folding portion 102, respectively. Therefore, the first folding portion 101, the second folding portion 102 and the fixing portion 103 can form the operating surface 104 for the user to use. Therefore, a bearing capacity of the first folding portion 101 and the second folding portion 102 can be improved by the supporting member 30, so that the workbench 100 can bear a heavier external object. It should be understood that the first folding portion 101/the second folding portion 102 can be expanded or folded by other common methods. For example, a limiting structure can be disposed at a position at which the first folding portion 101/the second folding portion 102 is connected to the fixing portion 103. The limiting structure can be configured for preventing the first folding portion 101/the second folding portion 102 from rotating relative to the fixing portion 103, so that the first folding portion/the second folding portion 102 can form the operating surface 104 with the fixing portion 103.

Furthermore, a mounting frame 211 can be fixed to the first body 21 and/or the second frame body 22, and the supporting member 30 can be rotatably disposed on the mounting frame 211.

In some embodiments, when the first folding portion 101 and/or the second folding portion 102 is in a folding state, a gap can be defined between the first folding portion 101 and the mounting frame 211 and/or between the second folding portion 102 and the mounting frame 211. Therefore, the mounting frame 211 will not affect folding of the first folding portion 101 and/or the second folding portion 102. That is, the mounting frame 211 will not collide with the first folding portion 101 and/or the second folding portion 102.

In order to improve stability of the supporting member 30 when supporting the first folding portion 101/the second folding portion 102, a second accommodating groove 1051 can be defined on the back surface 105 of the first folding portion 101/the second folding portion 102. The second accommodating groove 1051 can accommodate and limit the supporting member 30, and a wall of the second accommodating groove 1051 can prevent the supporting member 30 from separating from the second accommodating groove 1051. Specifically, the second accommodating groove 1051 can be configured for accommodating the supporting member 30 and contacting and supporting a part of the first folding portion 101/the second folding portion 102 of the supporting member 30.

In some embodiments, referring to FIG. 14 to FIG. 16, in order to further improve stability of the supporting member 30 when supporting the first folding portion 101/the second folding portion 102, the operating portion 10 can further include a first locking member 40. The first locking member 40 can be disposed on a side near the supporting portion of the first folding portion 101 and/or a side near the supporting portion of the second folding portion 102, that is, the back surface 105 of the first folding portion 101 and/or the back surface 105 of the second folding portion 102. The first locking member 40 can be configured for fixing the supporting member 30 to the first folding portion 101 or the second folding portion 102.

In the present embodiment, the first locking member 40 can include a mounting portion 41 and a first locking portion 42. The mounting portion 41 can be fixed to the first folding portion 101 or the second folding portion 102. The first locking portion 42 can be movably connected to the mounting portion 41, and the first locking portion 42 can be configured for locking the supporting member 30 between the first folding portion 101 and the first locking portion 42 or between the second folding portion 102 and the first locking portion 42. It should be understood that in an embodiment not shown in the present disclosure, the first locking member 40 can be in other structures such as in a buckle structure, as long as the first locking member 40 can prevent the supporting member 30 from separating from the first folding portion 101 or the second folding portion 102.

It should be understood that when the first locking member 40 is disposed on the back surface 105 of the first folding portion or the back surface 105 of the second folding portion 102, the supporting member 30 can be fixed without the second accommodating groove 1051. That is, both the second accommodating groove 1051 and the first locking member 40 can be disposed on the workbench 100, or one of the second accommodating groove 1051 and the first locking member 40 can be disposed on the workbench 100.

In some embodiments, the supporting rod 212 can be a telescopic rod, which can facilitate adjusting a height of the operating portion 10. Therefore, the workbench 100 can be used in more situations.

Specifically, referring to FIG. 3 and FIG. 25 to FIG. 27, the supporting rod 212 can include an outer rod 2121 and an inner rod 2122, and the inner rod 2122 can slide in the outer rod 2121. A second locking member 215 can be disposed on the connecting rod 213. The second locking member 215 can be configured for locking the inner rod 2122 to a preset position on the outer rod 2121.

Furthermore, the second locking member 215 can include a second locking portion 2151 and a pushing portion 2152, which can be fixed to each other. A locking hole 21221 can be defined on the inner rod 2122, and a chute 2132 can be defined on the connecting rod 213. The user can control the pushing portion 2152 to slide in the chute 2132, so that the second locking portion 2151 can insert into the locking hole 21221 to lock the inner rod 2122 with the outer rod 2121. Alternatively, the second locking portion 2151 can separate from the locking hole 21221 to unlock the inner rod 2122 and the outer rod 2121.

In some embodiments, the supporting structure 20 can further include a second elastic member 216, which can be configured for applying an elastic force on the second locking portion 2151. When the inner rod 2122 slide to a preset position in the outer rod 2121, the second locking portion 2151 can automatically insert into the locking hole 21221 under the action of the second elastic member 216, and lock the inner rod 2122 at the preset position in the outer rod 2121.

In order to facilitate adjusting a height of the workbench 100, a plurality of locking holes 21221 can be defined on the inner rod 2122. The plurality of locking holes 21221 can be arranged along an axis of the inner rod 2122, so that a relative position between the inner rod 2122 and the outer rod 2121 can be more flexible.

Referring to FIG. 27, in order to improve stability of the second elastic member 216, a protrusion (not labelled) can be disposed at an end near the second elastic member 216 of the second locking portion 2151. A groove (not labelled) can be defined on the connecting rod 213. One end of the second elastic member 216 can be sleeved on the protrusion, and the other end of the elastic member 216 can be located in the groove.

In some embodiments, referring to FIG. 6, a mat 21222 can be disposed at an end away from the operating portion 10 of the inner rod 2122, and the mat 21222 can be disposed between the inner rod 2122 and the ground. The mat 21222 can be anti-skid members such as a rubber mat and the like, so as to avoid instability of the workbench 100 during use and reduce harm to the ground.

Furthermore, referring to FIG. 2, the supporting structure 20 further can include a first foldable plate 23 and a second foldable plate 24. A side away from the second foldable plate 24 of the first foldable plate 23 can be rotatably connected to the connecting rod 213 of the first frame body 21. A side away from the first foldable plate 23 of the second foldable plate 24 can be rotatably connected to the connecting rod 213 of the second frame body 22. The first foldable plate 23 can be rotatably connected to the second foldable plate 24. Therefore, when the first frame body 21 and the second frame body 22 are in the accommodating state, the first foldable plate 23 and the second foldable plate 24 can be folded up to reduce the space occupied by the workbench 100. Moreover, the first foldable plate 23 and the second foldable plate 24 can be expanded when the first frame body 21 and the second frame body 22 are in the expanding state, so as to bear tools or components to be used.

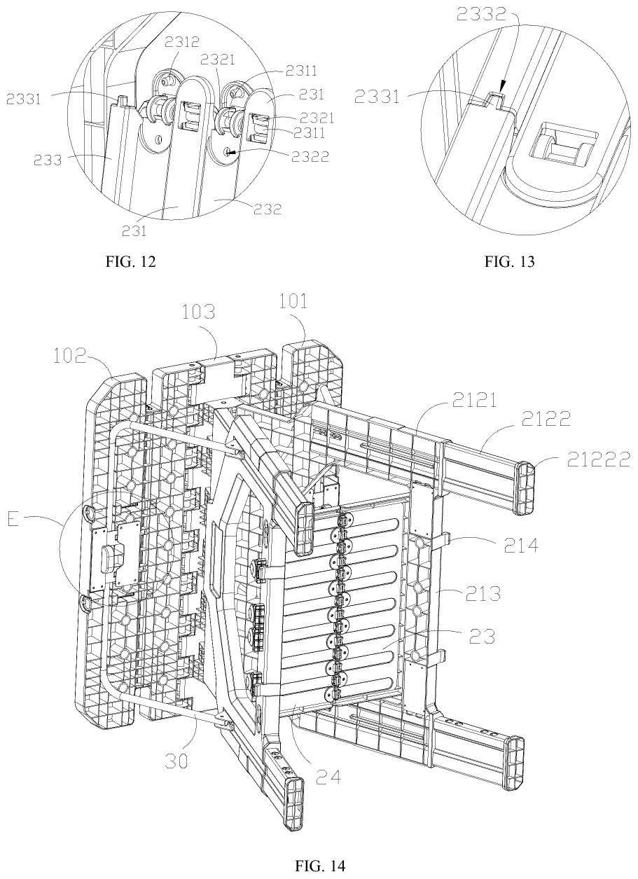

In the present embodiment, referring to FIG. 4 and FIG. 12, both the first foldable plate 23 and the second foldable plate 24 can include a plurality of axle pin plates 231 and a plurality of axle sleeve plates 232 which are staggered with each other. The plurality of axle pin plates 231 can be provided with a pin axle 2311, and the plurality of axle sleeve plates 232 can be provided with an axle sleeve 2321 matching with the pin axles 2311. The pin axle 2311 of the plurality of first foldable plates 23 can be disposed in the axle sleeve 2321 of the plurality of second foldable plates 24, and the pin axle 2311 of the plurality of second foldable plates 24 can be disposed in the axle sleeve 2321 of the plurality of first foldable plates 23, resulting in forming a rotatable connection between the first foldable plate 23 and the second foldable plate 24. It should be understood that the first foldable plate 23 and the second foldable plate 24 can be in other structures, as long as the first foldable plate 23 and the second foldable plate 24 can be folded up to accommodate or expand to form the bearing surface.

In some embodiments, the axle sleeve plate 232 of the first foldable plate 23 and the axle pin plate 231 of the first foldable plate 23 can be staggered disposed at a side near the second foldable plate 24 of the first foldable plate 23. Similarly, the axle sleeve plate 232 of the second foldable plate 24 and the axle pin plate 231 of the second foldable plate 24 can be staggered disposed at a side near the first foldable plate 23 of the second foldable plate 24. The first foldable plate 23 and the second foldable plate 24 can limit each other via the staggered disposed axle sleeve plate 232 and the axle pin plate 231, so that the first foldable plate 23 and the second foldable plate 24 can form a stable bearing surface in the expanding state.

In order to improve stability of the first foldable plate 23 and the second foldable plate 24 in the expanding state, in some embodiments, a limiting member 2312 can be disposed on and protrude from the pin axle plate 231, and a limiting hole 2322 can be defined on the axle sleeve plate 232, and the limiting member 2312 can be disposed in the limiting hole. It should be understood that the limiting hole 2322 can be a through hole or a blind hole, as long as the limiting member 2312 can be inserted in and clipped to the limiting hole 2322.

Both the first foldable plate 23 and the second foldable plate 24 can include a peripheral plate 233, which can be located around the axle pin plate 231 and the axle sleeve plate 232.

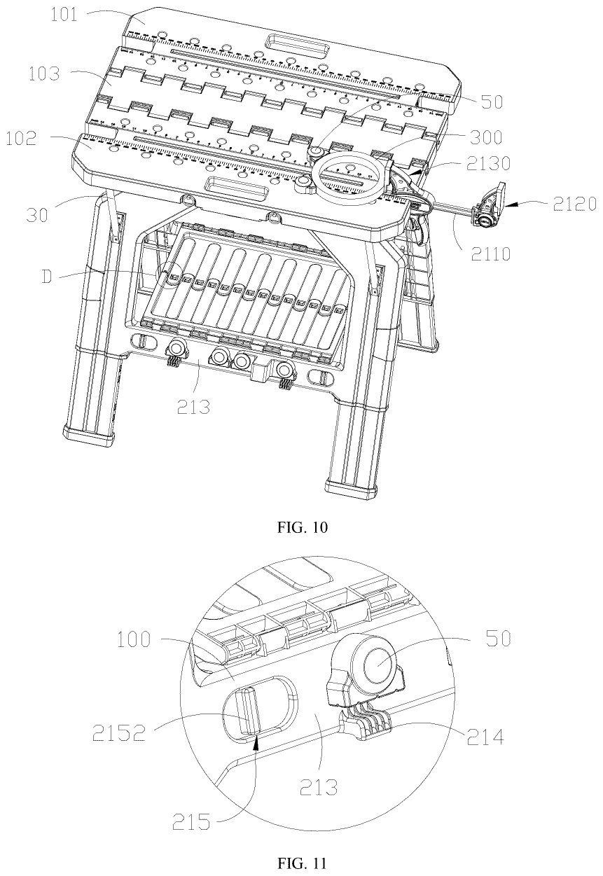

Furthermore, referring to FIG. 10 and FIG. 13, the peripheral plate 233 of the first foldable plate 23 can be provided with a stopper 2331, and the peripheral plate 233 of the second foldable plate 24 can be provided with a limiting groove 2332. Alternatively, the peripheral plate 233 of the second foldable plate 24 can be provided with the stopper 2331, and the peripheral plate 233 of the first foldable plate 23 can be provided with the limiting groove 2332. The limiting groove 2332 can be configured for accommodating and limiting the stopper 2331, so as to limit a rotation angle defined between the first foldable plate 23 and the second foldable plate 24.

It should be understood that the first foldable plate 23 and the second foldable plate 24 can limit each other merely via the staggered disposed axle sleeve plate 232 and the axle pin plate 231. Alternatively, the first foldable plate 23 and the second foldable plate 24 can limit each other merely via cooperation between the stopper 2332 and the limiting groove 2332. Alternatively, the first foldable plate 23 and the second foldable plate 24 can limited each other via combination of the two kinds of limiting structures, which are not limited in the present disclosure.

Referring to FIG. 8 and FIG. 10, in order to further improve using flexibility of the workbench 100 when clamping the external object 300, in some embodiments, the workbench 100 can further include a first fixing member 50, which can further include a third clamping surface 51. The first fixing member 50 can be disposed on the operating portion 10. A second clamping surface 21301 of the movable fixture body 2130 and the third clamping surface 51 can cooperate with each other to clamp the external object 300.

A distance between two adjacent second mounting holes 14 of the plurality of second mounting holes 14 can match a depth of the second groove 1011. When the second clamping surface 21301 of the movable fixture body 2130 matches with the third clamping structure 51 of the first fixing member 50, the second clamping surface 21301 can contact with the third clamping surface 51. Therefore, any external objects with different sizes can be clamped, and the workbench 100 can be widely used. In the present disclosure, the depth of the second groove 1011 is a depth of the second groove 1011 inserting into the first accommodating groove 11 along an inserting direction.

Referring to FIG. 17 and FIG. 18, specifically, the mounting member 52 can be disposed on the first fixing member 50 and protrude out from the first fixing member 50. The second mounting hole 14 can be defined on the operating portion 10, and the mounting member 52 can be able to insert into the second mounting hole 14, so that the first fixing member 50 can be disposed on the operating portion 10.

In some embodiments, referring to FIG. 8, a plurality of second mounting holes 14 can be defined on the operating portion 10, and the plurality of second mounting holes 14 can be divided into two sets. The two sets of the plurality of second mounting holes 14 can be located at two sides of the first accommodating groove 11, respectively.

Furthermore, two mounting members 52 can be disposed on the first fixing member 50 and protrude from the first fixing member 50. The two mounting members 52 can insert into two of the plurality of second mounting holes 14 on two sides of the first accommodating groove 11, respectively.

In some embodiments, one mounting member 52 can be disposed on the first fixing member 50. Referring to FIG. 10, two first fixing members 50 can insert into two the second mounting holes 14, respectively. The two third clamping surfaces 51 of the two first fixing members 50 can cooperate with the second clamping surface 21301 of the movable fixture body 2130 to clamp the external object 300. This can facilitate clamping an external object 300 which is not in square-shaped. For example, this can facilitate clamping a structure having a circle-shaped peripheral wall.

In some embodiments, the two sets of second mounting holes 14 can be aligned in pairs with the first accommodating groove 11 as a center line, respectively. A line defined by two corresponding second mounting holes in a pair can be perpendicular to an axis of the first accommodating groove 11. The second mounting holes 14 in each of the two sets are evenly distributed along the axis of the first accommodating groove 11. It should be understood that the second mounting holes 14 can be distributed in other methods, which are not limited in the present disclosure.

Furthermore, in each of the two sets of the plurality of second mounting holes 14, a distance between two adjacent second mounting holes 14 of the plurality of second mounting holes 14 can be less than or equal to a depth of the second groove 1011. In some embodiments, in each of the two sets of the plurality of second mounting holes 14, the distance between two adjacent second mounting holes 14 of the plurality of second mounting holes 14 can be a little less than the depth of the second groove 1011. Therefore, the second clamping surface 21301 of the movable fixture body 2130 and the third clamping surface 51 of the first fixing member 50 can define a continuously range of clamping the external object by designing the distance between two adjacent second mounting holes 14 of the plurality of second mounting holes 14. Thus, the workbench 100 can be used to clamp the external object 300 with any size, even if the external object 300 is very small.

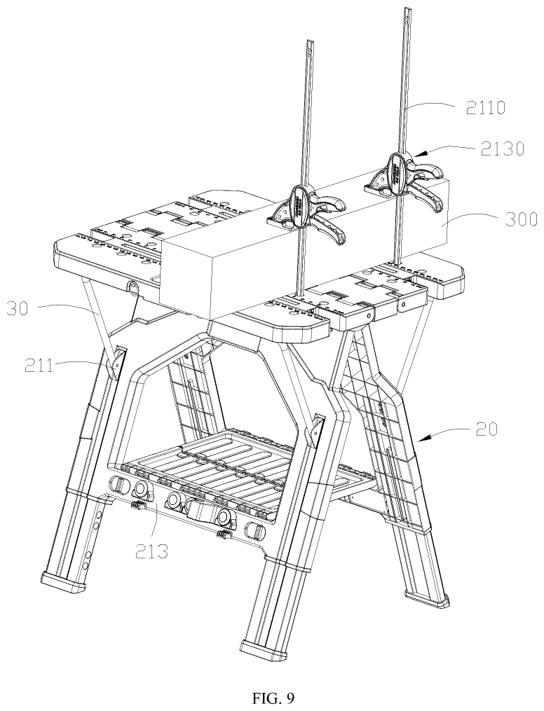

In some embodiments, the second mounting hole 14 can be configured for inserting the rod 2110 of the fixture 210. The rod 2110 can be detachably fixed to the second mounting hole 14 via the first locating portion 12, and the rod 2110 can be perpendicular to the operating surface 104 of the workbench 100. Referring to FIG. 9, the operating surface 104 of the workbench 100 can cooperate with the movable fixture body 2130 of the fixture 210 to clamp the external object 300. Therefore, not only the rod 2110 can be detachably fixed to the first accommodating groove 11 via the first locating portion 12, but also the rod 2110 can be detachably fixed in the second mounting hole 14 via the first locating portion 12. Moreover, the second mounting hole 14 not only can cooperate with the first fixing member 50, but also can cooperate with the rod 2110. Therefore, the workbench 100 can be more widely used. It should be understood that an angle defined by the rod 2110 and the workbench 100 can be in other degrees, which is not limited to 90 degrees. Other mounting holes can further be defined on the operating portion 10, so that other angles can be defined between the rod 2100 and the operating surface 104 of the workbench 100.

It should be understood that when the fixture 210 cooperates with the workbench 100, two second clamping surfaces 21301 can cooperate with each other to clamp the external object 300 (not shown in the figures). In some embodiments, referring to FIG. 8 and FIG. 10, the second clamping surface 21301 of the fixture 210 can cooperate with the third clamping surface 51 of the first fixing member 50 to clamp the external member 300. In some embodiments, referring to FIG. 9, the second clamping surface 21301 of the fixture 210 can cooperate with the operating surface 104 of the workbench 100 to clamp the external object 300.

In order to facilitate accommodating the first fixing member 50, an accommodating hole 2131 can be defined on the connecting rod 213 in some embodiments. Referring to FIG. 11 and FIG. 19, the first fixing member 50 can insert into the accommodating hole 2131 via the mounting member 52. It should be understood that the accommodating hole 2131 can be defined at other positions of the supporting structure 20, as long as the accommodating hole 2131 can accommodate the first fixing member 50, which are not limited in the present disclosure.

Referring to FIG. 19 to FIG. 29, the present disclosure further provides a second embodiment which is basically the same with the first embodiments. The differences between the first embodiment and the second embodiment are shown herein: firstly, the second embodiment does not include the first folding portion 101 and the second folding portion 102; secondly, a first accommodating groove 11 of the second embodiment can be disposed on a fixing portion 103; and thirdly, a first locating portion 12 of the second embodiment can have a different structure to the first locating portion 12 of the first embodiment.

The first different and the second difference have been described in detail in paragraphs illustrating the first embodiment, which are not repeated herein. The third difference will be described in details hereinafter.

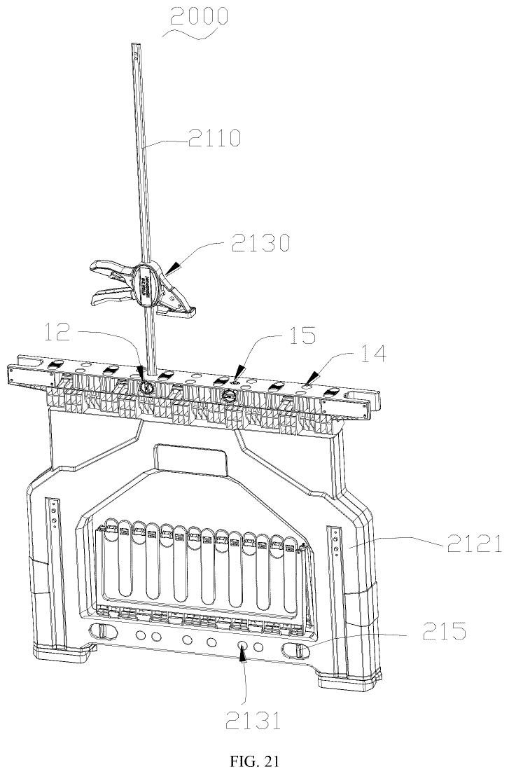

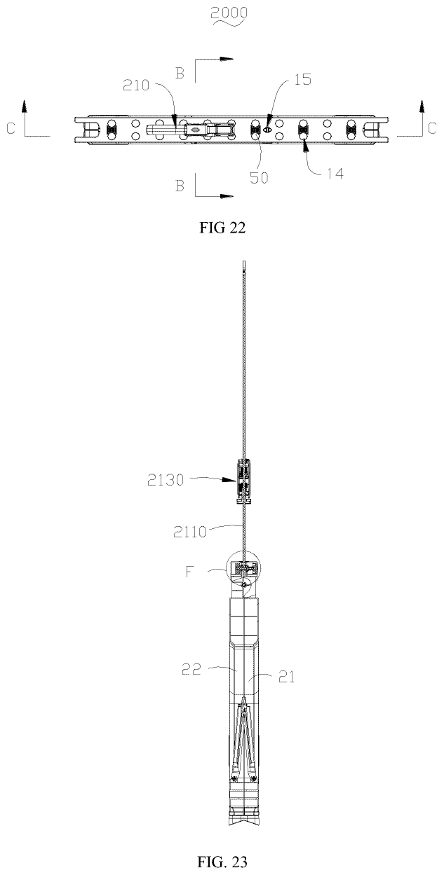

Referring to FIG. 19, FIG. 21 and FIG. 22, in the second embodiment, a third mounting hole 15 can be defined on the operating portion 10. The rod 2110 of the fixture 210 can insert into the third mounting hole 15. The rod 2110 can be detachably fixed to the third mounting hole 15, and a first present angle can be defined by the operating surface 104 of the workbench 100 and the rod 2110. The operating surface 104 of the workbench 100 can cooperate with the movable fixture body 2130 of the fixture 210 to clamp an external object 300.

In some embodiments, a shape of the third mounting hole 15 can match with a shape of a cross-section of the rod 2110 to improve stability of the rod 2110 during use.

In some embodiments, the rod 2110 can be perpendicular to the operating surface 104. It should be understood that an angle between the rod 2110 and operating surface 104 of the workbench 100 can be in other degrees, and is not limited to 90 degrees.

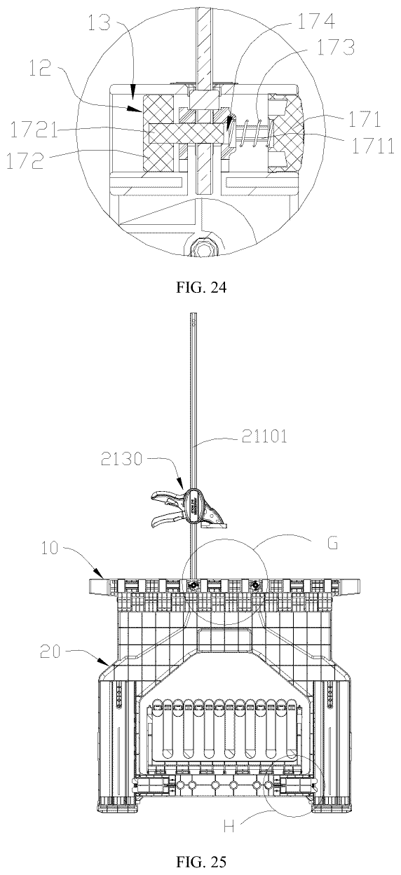

Referring to FIG. 19, FIG. 23 and FIG. 24, in order to facilitate fixing the rod 2110, the workbench 100 can include a first locating portion 12. A first mounting hole 13 can be defined on the workbench 100, and the first mounting hole 13 can penetrate through the third mounting hole 15. The rod 2110 can be detachably fixed to the first mounting hole 13 via the first locating portion 12, and the first locating portion 12 can be able to insert into the third mounting hole 15 and prevent the rod 2110 from moving. It should be understood that either the first locating portion 12 in the second embodiment or the first locating portion 12 in the first embodiment can be used in the workbench 100 of the present disclosure, and both of them can fix the rod 2110.

Specifically, in the second embodiment, the first locating portion 12 can include a first pressing member 171, a second pressing member 172 and a third elastic member 173. The first pressing member 171 and the second pressing member 172 can be fixed to each other, and can be accommodated in the third mounting hole 15. Two ends of the third elastic member 173 can abut against the first pressing member 171 and the workbench 100, respectively. A locating column 1721 can be disposed on the second pressing member 172, and a mounting gap 174 can be formed between the locating column 1721 and the first pressing member 171. The first pressing member 171 can be configured for driving the second pressing member 172 to move, resulting in the mounting gap 174 moving to the third mounting hole 15 for the rod 2110 to insert in. A part of the locating column 1721 can insert in the locating hole 21101 of the rod 2110 under an elastic effect of the third elastic member 173, resulting in the rod 2110 being detachably fixed in the first mounting hole 13.

In some embodiments, the first accommodating groove 11, the third mounting hole 15 and the first mounting hole 13 can communicate with each other, and the first locating hole 12 can be configured for locking the rod 2110 to the first accommodating groove 11 or the third mounting hole 15. Furthermore, an axis of the first accommodating groove 11 can be perpendicular to an axis of the third mounting hole 15 and the axis of the first mounting hole 13, and the axis of the third mounting hole 15 can be perpendicular to an axis of the first accommodating groove 11 and the axis of the first mounting hole 13, and the axis of the first mounting hole 13 can be perpendicular to the axis of the first accommodating groove 11 and the axis of the third mounting hole 15.

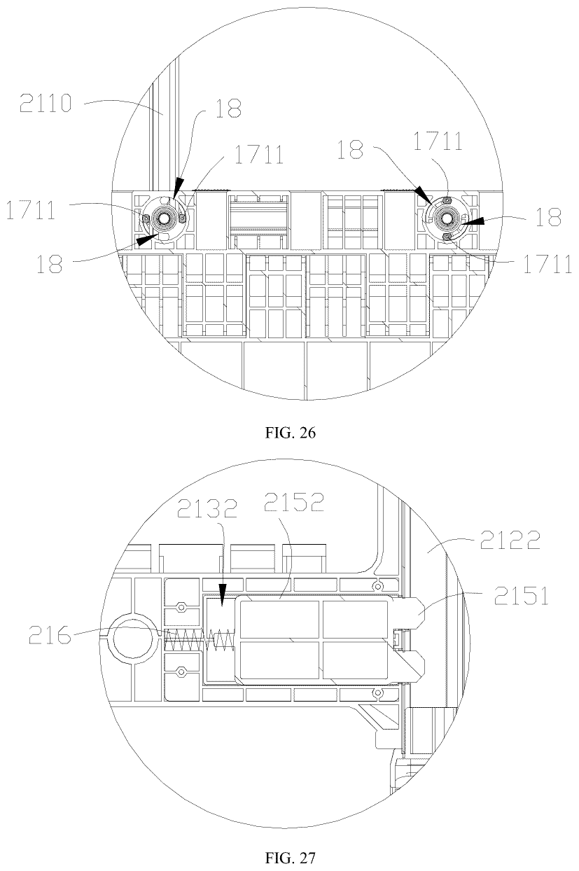

Referring to FIG. 24 and FIG. 26, the first pressing member 171 can be provided with a connecting member, and the first pressing member 171 can be fixed to the second pressing member 172 via the connecting member 1711. The operating portion 10 can include an arc-shaped groove 18, the first pressing member 171 can be able to rotate and drive the connecting member 1711 to rotate in the arc-shaped groove 18 to prevent collisions with the rod 2110. When the rod 2110 is detachably fixed in the first accommodating groove 11, the user can rotate the first pressing member 171 to drive the connecting member 1711 to leave the first accommodating groove 11 and prevent the connecting member 1711 from colliding with the rod 2110. When the rod 2110 is detachably fixed in the third mounting hole 15, the user can rotate the first pressing member 171 to drive the connecting member 1711 from leaving the third mounting hole 15 and prevent the connecting member 1711 from colliding with the rod 2110.

In the present disclosure, when the workbench 100 is used together with a fixture 210, a rod 2110 of the fixture 210 can be detachably accommodated in an accommodating groove 11 to prevent an external object 300 from rubbing against the rod 2110, thereby prolonging a service life of a fixture 210. In the present disclosure, the workbench 100 improves stability of the fixture 210, so that the fixture 210 will not roll over during use. Moreover, since the rod 2110 is fixed to the workbench 100, safety hazards caused by moving the rod 2110 can be decreased. In addition, the user can clamp the external object 300 by merely handling a movable fixture body 2130 of the fixture 210, which is convenient for the user.

In addition, in the related art, when the workbench is operated, it usually requires some auxiliary tools to fit to process the external object. In order to facilitate the operation, the auxiliary tools to be operated (such as clamp, grinding tools, electric tools, etc) are usually disposed on the workbench. However, such simple disposing method may enable the auxiliary tools to be easy to accidentally move, be knocked over, or dropped out, resulting in damage to a workpiece, or affecting a processing process.

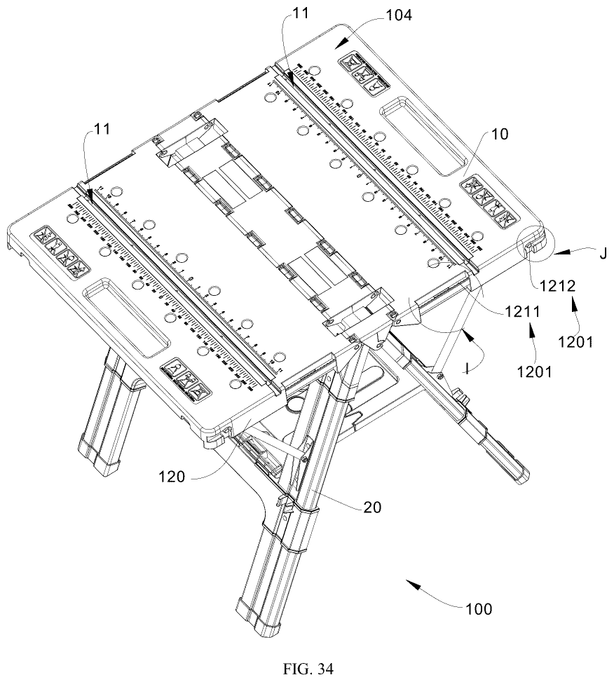

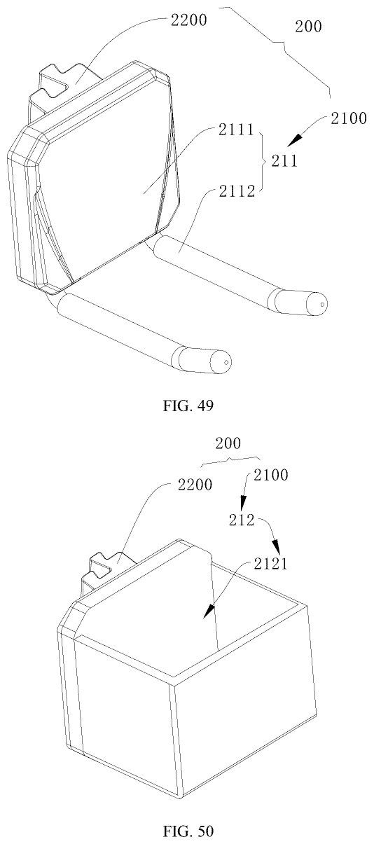

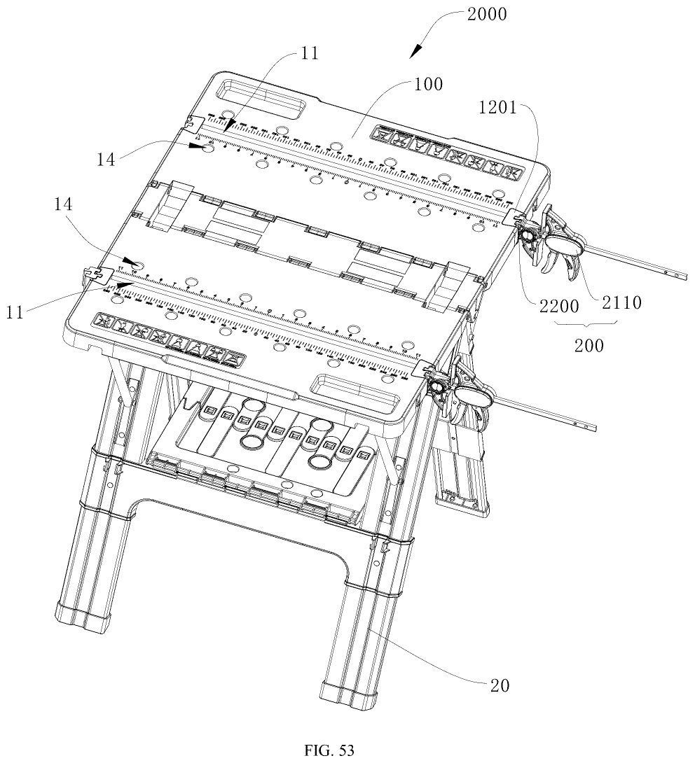

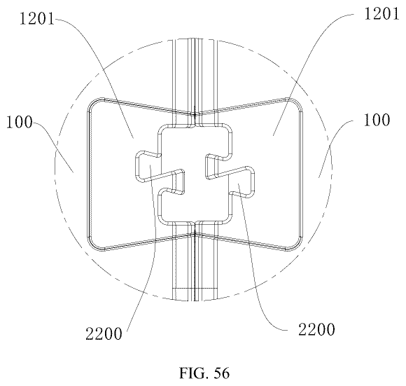

Based on above description, the present disclosure provides some embodiments, referring to FIGS. 34 to 63, the inventive concept and most of structures of the workbench 100 of the workbench module 2000 in theses embodiments are substantially the same as that of the workbench 100 of above embodiments, the differences are as follows: a operating portion 10 of the workbench 100 is provided with at least one fitting member 1201, and the fitting member 1201 is located on a periphery side of the operating portion 10, which is configured to detachably connected to a fitted member 200. The fitted member 200 includes but not limited the workpiece having an auxiliary effect, such as a storage tool, an electrical tool and so on.

In other words, the present disclosure provides the workbench 100, the fitted member 200 can be detachably mounted or accommodated on the periphery side of the operating portion 10 by the fitting member 1201, thereby reducing a risk of the fitted member 200 accidentally moving or falling off and preventing the fitted member 200 from obstructing the operation surface 104. The fitted member 200 is detachably connected to the fitting member 1201 and the fitted member 200 is easy to be replaced, facilitating an operation of the operator, and improving an overall efficiency of processing and assembling productions.

The operating portion 10 can be metal, wood, plastic or other materials. An operation surface 104 of the operating portion 10 can be in a circular shape, a polygonal shape, or other shapes, as long as it will not affect an use of the workbench 100 and a fit between the fitting member 1201 and the fitted member 200, which is not limited herein. In order to be applicable to more scenarios, the operating portion 10 can be designed as a plate shape.

Furthermore, the fitting member 1201 and operating portion 10 can be an integral structure or a separately structure. When the fitting member 1201 and the operating portion 10 are the integral structure, it can simplify a production process, reduce a production cost and improve a production efficiency. When the fitting member 1201 and the operating portion 10 are separate structures, the fitting member 1201 can be detachably connected to the operating portion 10, which is conducive to replacing different fitting portions 1201 and having a wider application for the workbench 100.

The fitting member 1201 can be disposed on a side wall 120 of the operating portion 10 or a part of the operation surface 104 towards the side wall 120. In other words, the position and number of the fitting member 1201 is not limited herein, as long as the fitting member 1201 can detachably fit with the fitted member 200 to enable the fitted member 200 to be mounted on the periphery side of the operating portion 10.

For example, an extending direction of the operation surface 104 is defined as a horizontal direction, a direction being perpendicular to the operation surface 104 is defined as a vertical direction. The supporting structure 20 is located under the operating portion 10 along the vertical direction.

In some embodiments, the fitting member 1201 and the operating portion 10 are the integral structure formed by an integral process.

For example, referring to FIGS. 34 to 45, in one embodiment, the fitting member 1201 includes a first fitting portion 1211. The first fitting portion 1211 is a snapping groove 12110 formed on the operating portion 10. In particular, the first fitting portion 1211 can be a snapping groove 12110 formed on the operation surface 104 along the vertical direction, a groove opening of the snapping groove 12110 faces upwards, such that the fitted member 200 is snapped with the snapping groove 12110 to be hooked on the periphery side of the operating portion 10. A structure of the snapping groove 12110 is simple, an installation step is simple, which is conducive to quickly fitting with the fitted member 200.

In other embodiment, a snapping groove 12110 is formed on a side wall 120 of the operating portion 10 along a direction parallel to the operation surface 104 (i.e., the horizontal direction), such that the groove opening faces the periphery side of the workbench 100 and the fitted member 200 is snapped with the snapping groove 12110 along the horizontal direction.

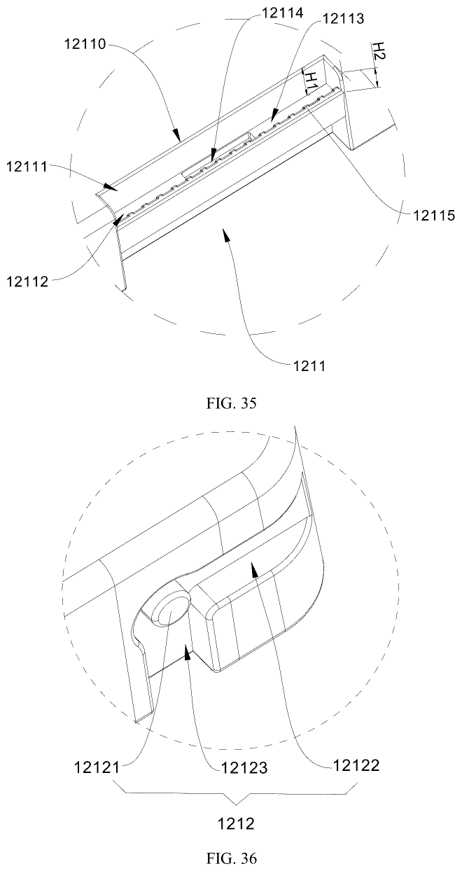

For example, referring to FIGS. 34 and 35, the snapping groove 12110 is formed on an edge of the operating portion 10, the snapping groove 12110 have a first groove opening 12111 with a groove opening upwards, and the first groove opening 12111 is formed on the operation surface 104. The fitted member 200 is stably snapped with the fitting member 1201 via the gravity.

For example, a shape of the snapping groove 12110 is cuboid, and a shape of the first groove opening 12111 is rectangle.

Referring to FIGS. 34 and 35, furthermore, the snapping groove 12110 further includes a second groove opening 12112 in communication with the first groove opening 12111. The second groove opening 12112 is formed on the side wall 120. A size H2 of the second groove opening 12112 along the snapping groove 12110 is less than a size H1 of the snapping groove 12110. The depth direction of the snapping groove 12110 herein is a direction perpendicular to the operation surface 104, and “the size H1 of the snapping groove 12110” is a depth of the snapping groove 12110 along a direction perpendicular to the operation surface 104.

A surface of the first groove opening 12111 is perpendicular to a surface of the second groove opening 12112.

For example, the second groove opening 12112 is disposed on an upper part of the side wall 120. Along the vertical direction, a lower edge of the second groove opening 12112 is lower than the operation surface 104 of the workbench 100, such that a space is formed for installing the fitted member 200. After the snapping groove 200 being snapped with the snapping groove 12110, an upper surface of the fitted member 200 does not protrude out from the operation surface 104, thereby ensuring evenness of the operation surface 104, facilitating the operator to operating, and facilitating processing and assembling the product.

Referring to FIGS. 34 and 35, furthermore, at least part of the snapping groove 12110 penetrates through the operating portion 10 along the vertical direction, i.e., at least part of the snapping groove 12110 penetrates through the operating portion 10 along a direction perpendicular to the operation surface 104.

By such arrangement, the fitted member 200 is snapped with a part of the snapping groove 12110 penetrating through the workbench 100 as required, thereby increasing a snapping depth and a snapping area, such that the fitted member 200 and the snapping groove 12110 are more firm after being mounted, and not easy to slide or drop off.

For example, along the vertical direction, the snapping groove 12110 includes a first groove segment 12113 and a second groove segment 12114 in communication with each other. The second groove segment 12114 is formed on a bottom wall of the first groove segment 12113. The second groove segment 12114 penetrates through the operating portion 10 along the vertical direction. A bottom wall of the first groove segment 12113 is a plane. The first groove segment 12113 and the second groove segment 12114 can both detachably fit with the fitted member 200. The second groove segment 12114 can improve firmness and reliability of the installation.

For example, the second groove segment 12114 is located in a middle of the bottom wall of the first groove segment 12113.

Referring to FIGS. 34 and 35, for example, an inner side wall of the snapping groove 12110 is provided with at least one limiting lock block 12115 protruding outwards. Furthermore, when the number of the limiting lock blocks 12115 is multiple, a plurality of limiting lock blocks 12115 can be uniformly disposed at interval. Therefore, it is conducive for the fitted member 200 to be selectively located and snapped on different positions of the snapping groove 12110 as required.

In other embodiments, the snapping groove 12110 can penetrate through the workbench 100 along the vertical direction.

Referring to FIGS. 34 and 36, in some embodiments, the fitting member 1201 includes a second fitting portion 1212. The second fitting portion 1212 includes a connecting protrusion 12121. A structure of the connecting protrusion 12121 is simple, which can directly match with the fitted member 200 or fit with the fitted member 200 to play other roles. For example, the connecting protrusion 12121 is in a cylinder shape.

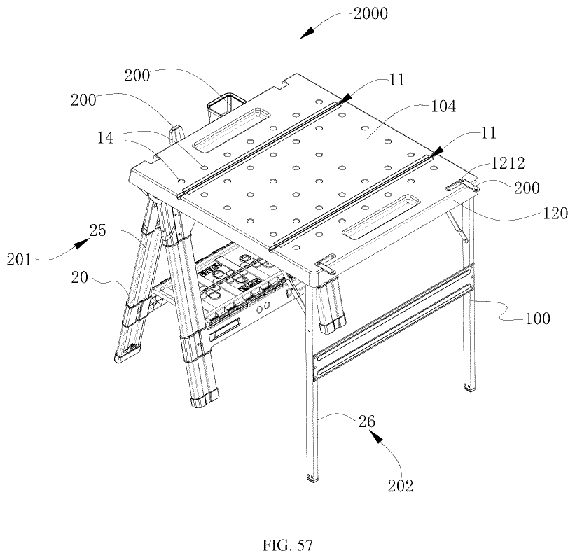

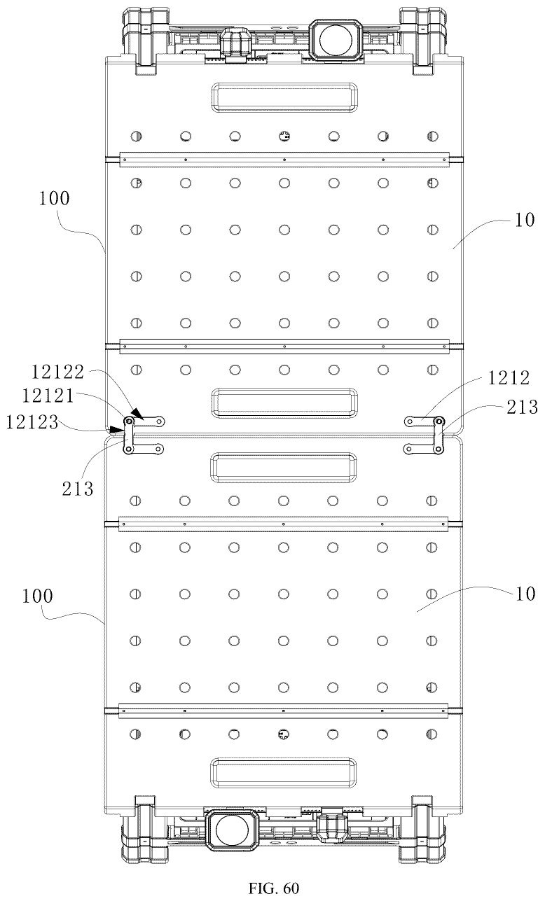

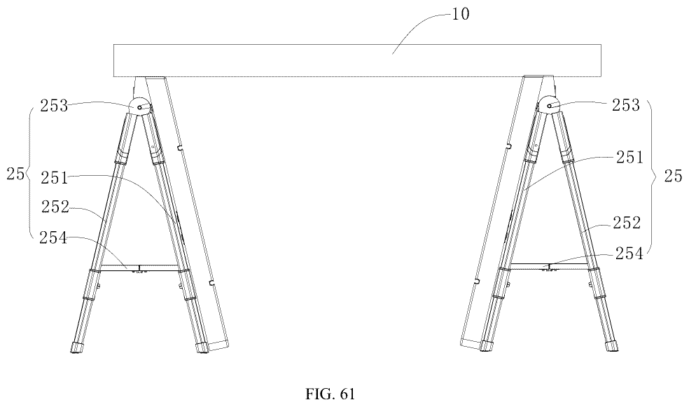

Referring to FIGS. 34 and 36, in this embodiment, the second fitting portion 1212 is disposed on the side wall 120, and the connecting protrusion 12121 correspondingly protrudes out from the side wall 120. In other embodiments, referring to FIGS. 57 and 60, the second fitting portion 1212 can be disposed on the operation surface 104, and the connecting protrusion 12121 correspondingly protrudes out from the operation surface 104.

Furthermore, in this embodiment, the second fitting portion 1212 further includes a first adaptation groove 12122 and a second adaptation groove 12123 in communication with each other. A depth of the first adaptation groove 12122 and a depth of the second adaptation groove 12123 are perpendicular to a protruding direction of the connecting protrusion 12121. A length of the first adaptation groove 12122 is perpendicular to a length of the second adaptation groove 12123. The connecting protrusion 12121 is located on a communication position or an overlapping part between the first adaptation groove 12122 and the second adaptation groove 12123. The fitted member 200 can be detachably sleeved on the connecting protrusion 12121, be capable of rotating, and be accommodated in the first adaptation groove 12122 or the second adaptation groove 12123 as required. In other embodiments, the first adaptation groove 12122 and the second adaptation groove 12123 can not be provided, or one of the first adaptation groove 12122 and the second adaptation groove 12123 can be provided.

Referring to FIGS. 34 and 36, for example, in one embodiment, the protruding direction of the connecting protrusion 12121 is vertical to the side wall 120. The first adaptation groove 12122 extends along the horizontal direction. The second adaptation groove 12123 extends along the vertical direction.

Furthermore, a shape of the first adaptation groove 12122 is same as that of the second adaptation groove 12123, and a size of the first adaptation groove 12122 is same as that of the second adaptation groove 12123, which is conducive to fitting the fitted member 200 to switch an accommodating position.

In some embodiments, the fitting member 1201 and the operating portion 10 can be a separated structure.

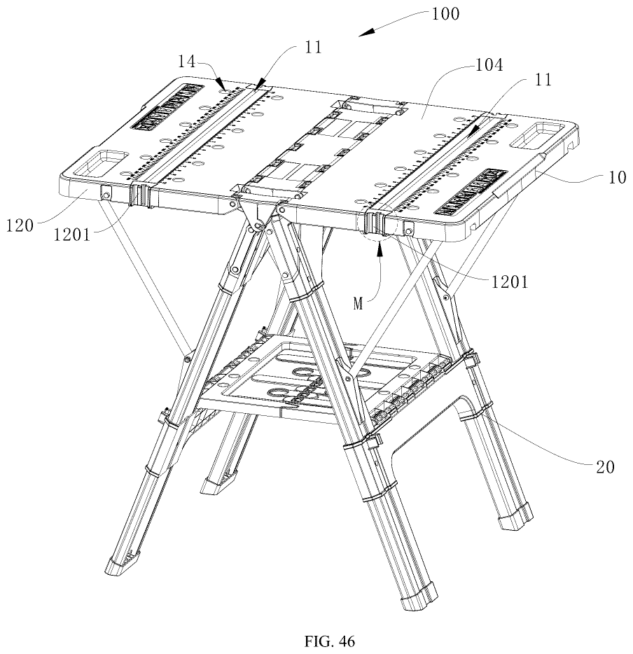

Referring to FIGS. 46 to 48, for example, in one embodiment, the fitting member 1201 further includes a third fitting portion 1213. A side wall 120 of the operating portion 10 is provided with an mounting notch 1203. The mounting notch 1203 penetrates through the operating portion 10 along a vertical direction. The third fitting portion 1213 can be detachably mounted on the mounting notch 1203. In some embodiments, the second groove 1011 of the operating portion 10 can be used as an mounting notch 1203.

In order to prevent the third fitting portion 1213 from detaching and dropping out, in one embodiment, the operating portion 10 further includes a bearing portion 1202. The bearing portion 1202 is located on a side of the mounting notch 1203 towards the back surface 105 of the operating portion 10. The bearing portion 1202 is configured to limit the third fitting portion 1213 and can abut against a part of a bottom of the third fitting portion 1213, thereby preventing the third fitting portion 1213 from detaching from the operating portion 10 along a direction perpendicular to the operation surface 104.

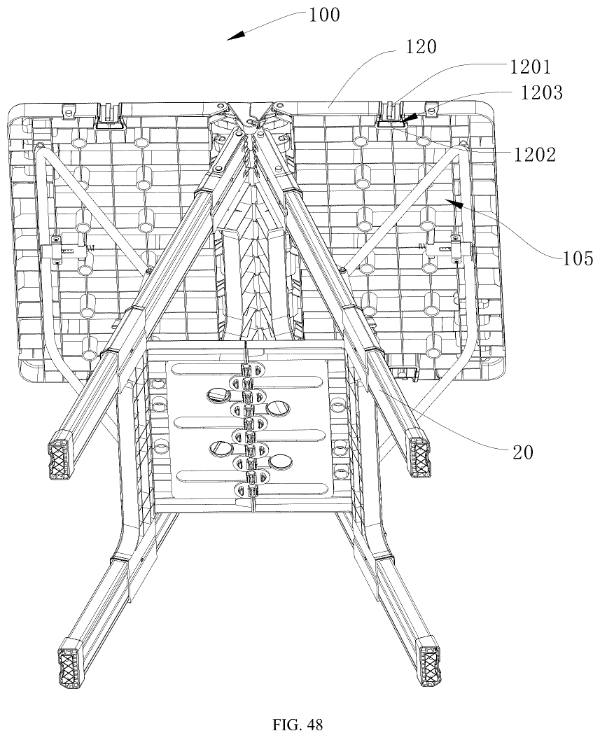

In particular, referring to FIG. 48, the bearing portion 1202 abuts against a side of the fitting member 1201 away from the operation surface 104. The bearing portion 1202 is configured as a limiting plate, and an edge of the side of the fitting member 1201 away from the operation surface 104 is lifted and supported by the limiting plate.

In other embodiment, the bearing portion 1202 can be disposed on a middle position or other positions of the side wall 120, as long as it can limit the fitting member 1201, which is not limited herein.

In this embodiment, the fitting member 1201 is limited by the bearing portion 1202 in a jacking method. In other embodiments, the fitting member 1201 can be limited by a snapping connection, a buckle connection or other methods, as long as it can limit the fitting member 1201, which is not limited herein. In other embodiments, the third fitting portion 1213 can be integrated with the operating portion 10, therefore, no bearing portion is provided.

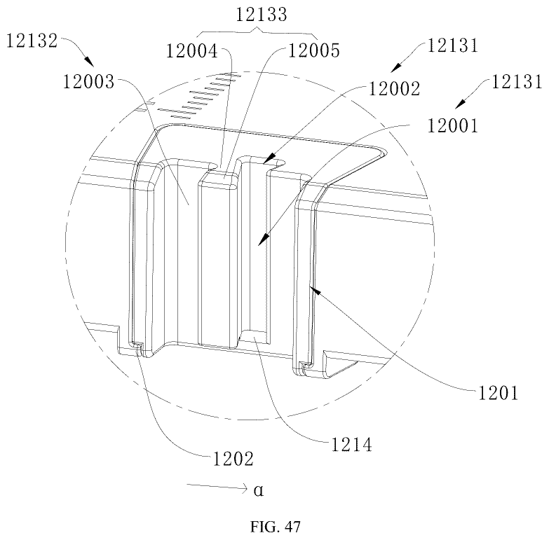

Referring to FIG. 47, the third fitting portion 1213 includes a first connecting groove 12131. A depth direction of the first connecting groove 12131 is vertical to the side wall 120. A size of the bottom wall of the first connecting groove 12131 along the width direction a of the first connecting groove 12131 is greater than that of the groove opening along a width direction a of the first connecting groove 12131. In order to facilitate distinguishing, a groove opening of the first connecting groove 12131 is defined as a third groove opening 12001. The first connecting groove 12131 is provided with a top groove opening 12002 located on the operation surface 104 along the vertical direction. The first connecting groove 12131 is provided with a barrier block 1214 on a side of first connecting groove 12131 away from the top groove opening 12002. Therefore, by designing a size and a shape of the first connecting groove 12131, the third fitting portion 1213 can enable the fitted member 200 to suffer from a force opposite to a depth direction of the first connecting groove 12131 along the horizontal direction and suffer from a bearing force from the barrier block 1214 along the vertical direction, thereby ensuring that the fitted member 200 is not separated from the fitting member 1201 after the fitted member 200 being snapped with the fitting member 1201.

A shape of the first connecting groove 12131 is similar to a swallowtail groove shape. The fitted member 200 can be provided with a convex portion fitting with the shape of the first connecting groove 12131. The fitted member 200 can be snapped into the top groove opening 12002 or detached from the first connecting groove 12131.

Furthermore, referring to FIG. 47, in some embodiment, the third fitting portion 1213 further includes a second connecting groove 12132 and a first protrusion 12133. The first connecting groove 12131 is formed on a bottom wall 12003 of the second connecting groove 12132. The first protrusion 12133 protrudes out from the bottom wall 12003 of the second connecting groove 12132. The first protrusion 12133 includes a connecting portion 12004 and a convex portion 12005. The connecting portion 12004 is connected to the bottom wall 12003 of the second connecting groove 12132. The connecting portion 12005 is connected to a side of the bottom wall 12003 of the connecting portion 12004 away from the second connecting groove 12132. The size of the connecting portion 12005 along the width direction a of the first connecting groove 12131 is greater than that of the connecting portion 12004 along the width direction a of the first connecting groove 12131.

Therefore, by providing with the second connecting groove 12132 and designing the size and the shape of the first protrusion 12133, it can further increase the force opposite to the depth direction of the first connecting groove 12131 on the fitted member 200 along the horizontal direction, such that an installation between the fitting member 1201 and the fitted member 200 is more firm and the fitting member 1201 is not easy to be detached from the fitted member 200. In particular, the fitted member 200 can be provided with a concave portion fitting with a shape of the first protrusion 12133, such that the fitted member 200 can suffer from a force opposite to a protruding direction of the first protrusion 12133 along the horizontal direction.

Referring to FIG. 47, in the present embodiment, a part of a periphery wall of the first protrusion 12133 is formed and defined as a part of an inner wall of the first connecting groove 12131. In other words, a side wall of a side of the first connecting groove 12131 overlaps with a periphery wall of a side of the first protrusion 12133. In other embodiments, the first connecting groove 12131 can be separated from the first protrusion 12133 and arranged in the second connecting groove 12132 at interval. The side wall of the first connecting groove 12131 and the periphery wall of the first protrusion 12133 can be a plane or a curved surface, as long as it will not affect a detachment and an installation of the fitted member 200, which is not limited herein.

Furthermore, in order to further improve connection strength, a plurality of first protrusions protrudes out from a bottom wall 12003 of the second connecting groove 12132, and a plurality of first connecting grooves 12131 can be disposed on the bottom wall 12003 of the second connecting groove 12132, which is not limited herein.

Referring to FIG. 47, in one embodiment, a connection position between the bottom wall of the second connecting groove 12132 and the periphery wall of the second connecting groove 12132 is an arc surface. A connection position between the first protrusion 12133 and the bottom wall of the first connecting groove 12131 is an arc surface. A design of the arc surface can improve installation smoothness of the fitted member 200, avoid stress concentration, and minimize a risk of damage to the fitting member 1201 and the fitted member 200.

In other embodiments, the connection position between the bottom wall of the second connecting groove 12132 and the periphery wall of the second connecting groove 12132 can be defined as having a right angle or in other shapes, and the connection position between the periphery wall of the first protrusion 12133 and the bottom wall of the first connecting groove 12131 can be defined as having a right angle or in other shapes, as long as it does not affect the fitting member 1201 fitting with the fitted member 200, which is not limited herein.

The operating portion 10 can provide with one or more of the first fitting portion 1211, the second first fitting portion 1212 and the third fitting portion 1213. The number and the position of the first fitting portion 1211, the second fitting portion 1212 and the third fitting portion 1213 can be set as required, which is not limited herein.

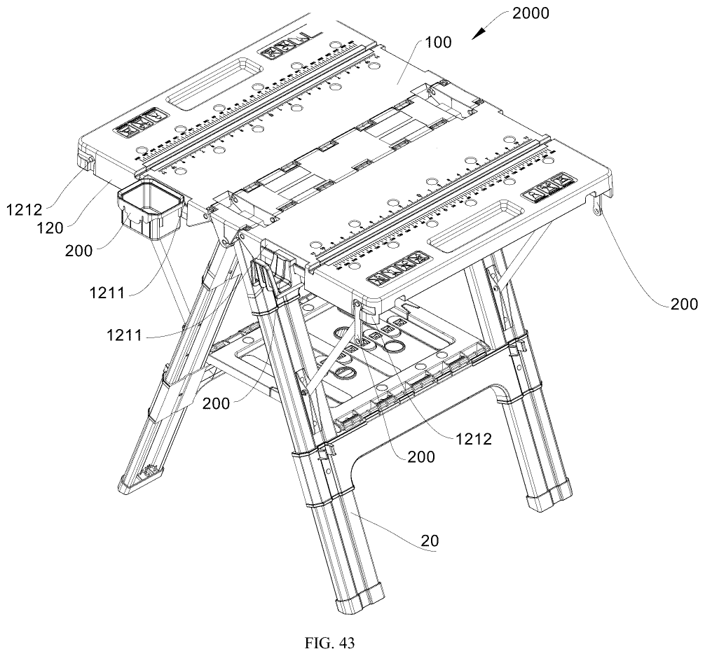

For example, referring to FIG. 43, in one embodiment, a side wall 120 of the operating portion 10 can be provided with two first fitting portions 1211 and two second fitting portions 1212. Along the horizontal direction, the two first fitting portions 1211 are located on a middle of the side wall 120, and the two second fitting portion 1212 are located on two edges of the side wall 120 respectively.

Referring to FIGS. 34 to 45, in some embodiment of the present disclosure, the workbench module 2000 includes at least one workbench 100 and at least one fitted member 200. The fitted member 200 includes a tool body 2100 and at least one fitting member 2200. The adaptation portion 2200 is disposed on the tool body 2100. The adaptation portion 2200 fits with at least part of the fitted member 1201 and detachably fits with the fitting member 1201 of the workbench 100.

In other words, in the workbench 100 and the fitted member 200 of the workbench module 2000 of the present disclosure, by a fit between the adaptation portion 2200 and the fitting member 1201, the fitted member 200 can be fixed on the workbench 100, which is conducive to processing and assembling the production, and having a wider application of the workbench module 2000.

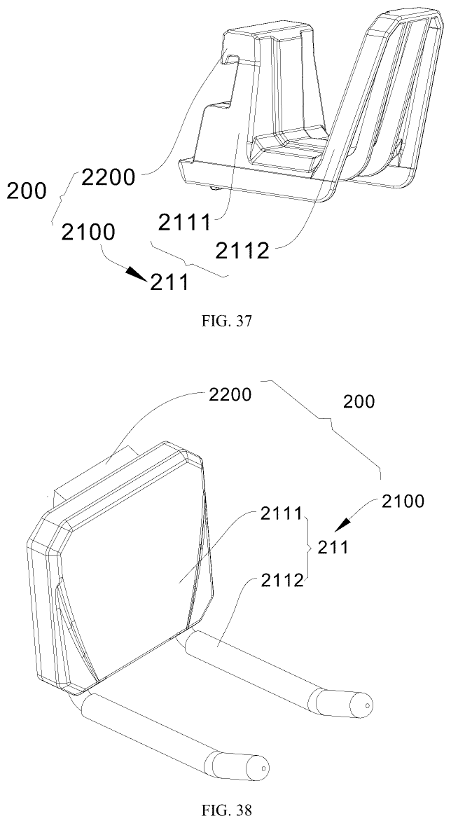

For example, in some embodiments, referring to FIGS. 37 to 44 and 46 to 56, the adaptation portion 2200 can be configured as a snapping block, the snapping block is configured to be snapped with the snapping groove 12110 of the first fitting portion 1211, or, be snapped with the first connecting groove 12131 of the third fitting portion 1213, the first protrusion 12133, and the second connecting groove 12132 of the third fitting portion 1213.

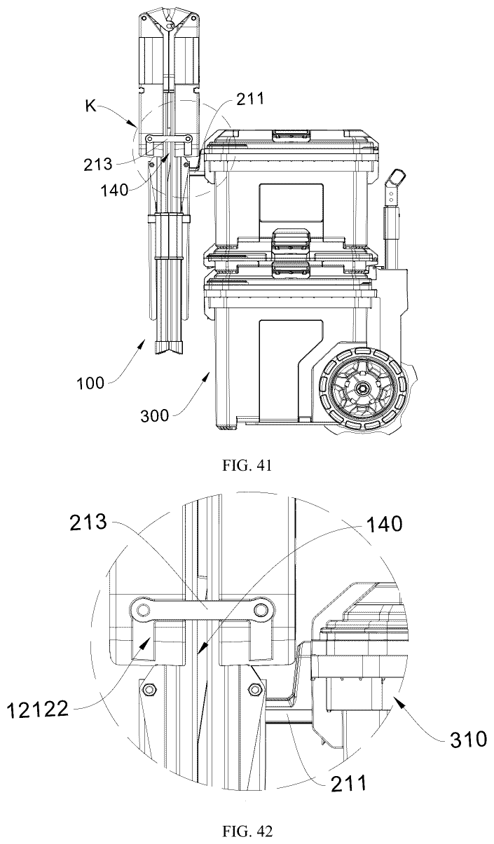

For example, in some embodiments, referring to FIG. 40, the adaptation portion 2200 can be configured as a through hole. The through hole is configured to be sleeved on the connecting protrusion 12121 of the second fitting portion 1212.

In other embodiment, the adaptation portion 2200 can be designed by the fitting member 1201, as long as it can fit with the fitting member 1201, which is not limited by being defined as the snapping block or the through hole.

Furthermore, the tool body 2100 includes but not limited by a hook 211, an accommodating box 212, a connecting member 213, a fixture 210 or another workbench 100.

Referring to FIGS. 37, 38 and 49, in other embodiments, the tool body 2100 is the hook 211. The hook 211 includes a fastening portion 2111 and a hook portion 2112. The hook portion 2112 is connected to the fastening portion 2111. The adaptation portion 2200 is disposed on a side of the fastening portion 2111 away from the hook portion 2112. The adaptation portion 2200 can be configured as a snapping block fitting with the fitting member 1201. The hook 211 is snapped on the first fitting portion 1211 or the third fitting portion 1213 by the adaptation portion 2200, such that the workbench 100 can hook tools and required objects by the hook 211.

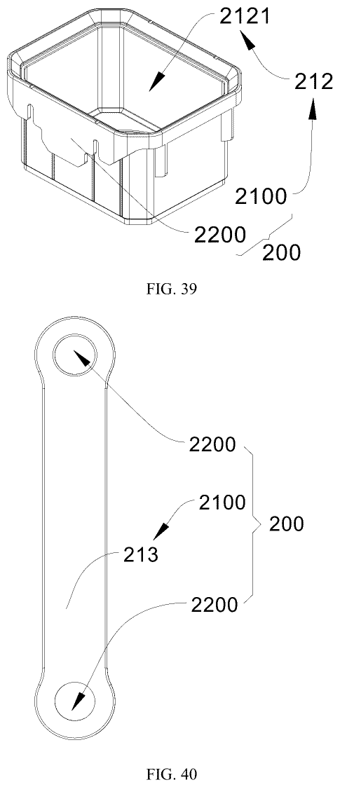

Referring to FIGS. 39 and 50, in some embodiments, the tool body 2100 is an accommodating box 212. The accommodating box 212 is provided with a cavity 2121. The adaptation portion 2200 is disposed on an outer periphery wall of the cavity 2121. The adaptation portion 2200 can configured as the snapping block, in which the snapping block fits with the fitting member 1201, and the accommodating box 212 is snapped with the first fitting portion 1211 or the third fitting portion 1213 by the adaptation portion 2200, such that the workbench 100 can store the tools and the required objects by the accommodating box 212.

When the accommodating box 212 is relatively large or has a heavy load-bearing capacity, a middle part of the adaptation portion 2200 can be snapped on the second groove segment 12114. In order to ensure a snapping depth, two sides of the adaptation portion 2200 can be snapped on the first groove segment 12113.

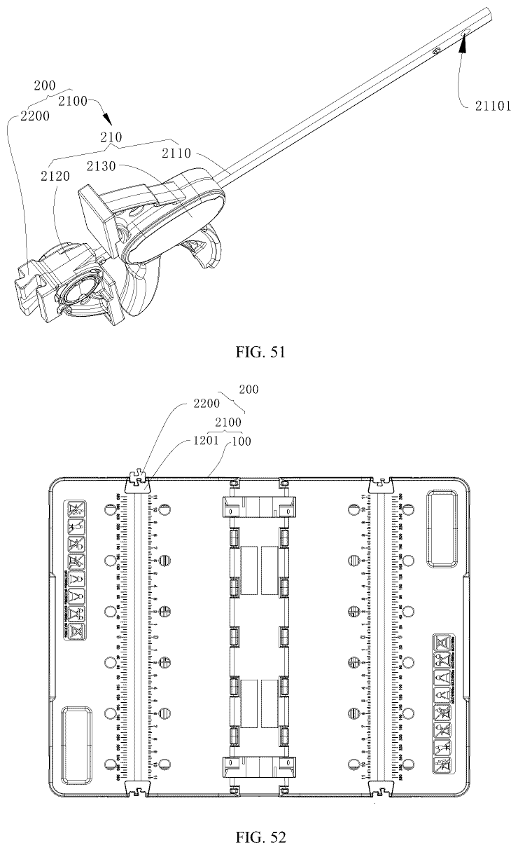

Referring to FIG. 51, in other embodiments, the tool body 2100 is a fixture 210. The fixture 210 includes a rod 2110 and a fixture module. The rod 2110 can penetrate through the fixture module. The adaptation portion 2200 is disposed on the fixture module. In particular, the fixture module includes a fixed fixture body 2120 and a movable fixture body 2130. The rod 2110 penetrates through the fixed fixture body 2120 and the movable fixture body 2130. A side of the fixed fixture body 2120 away from the locating hole 21101 of the rod 2110 is connected to the adaptation portion 2200. When the fixture 210 does not be used, the rod 2110 can move out of the first accommodating groove 11 and is accommodated on a periphery side of the workbench 100 by a fit between the adaptation portion 2200 and the fitting member 1201. Referring to FIG. 51, the adaptation portion 2200 can be configured as the snapping block, in which the snapping block fits with the adaptation portion 1201.

In other embodiments, the tool body 2100 can be a hanging basket, hanging rack, or other tools or equipment, as long as the tool body 2100 is connected to the adaptation portion 2200 and detachably connected to the fitting member 1201 of the workbench 100 by the fitting member 2200, which is not limited herein.

Referring to FIGS. 40 and 54, in other embodiments, the tool body 2100 can be a connecting member 213 with a preset length, the adaptation portion 2200 is disposed on two ends of the connecting member 213 opposite to each other, and the two adaptation portions 2200 can be detachably mounted on the fitting members 1201 of the two workbench 100 or two fitting members 1201 of one workbench 100.

By such arrangement, the connecting member 213 can play a role of connecting the two workbenches 100, thereby increasing a usable area of the work surface of the workbench module 2000, facilitating several operators to operating, and improving an efficiency of processing and assembling the product Alternatively, the connecting member 213 can play a role of connecting, and fix two sides of a folded single workbench 100, facilitating accommodation of the workbench 100,

The connecting member 213 can be flexible, which is referring to FIG. 40, the connecting member 213 can be rigid, which is referring to FIG. 54.

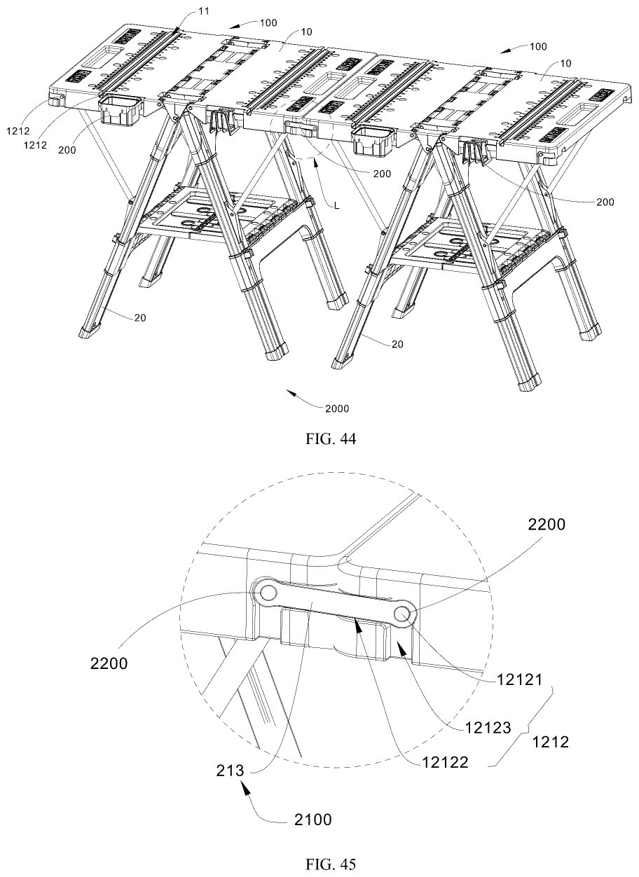

Referring to FIGS. 44, 55 and 60, in some embodiments, the connecting member 213 can be connected two workbenches 100 at a connecting position of the side walls 120 of the two workbenches 100 or can be connected the two workbenches 100 at a connecting position of the operation surfaces 104 of the two workbenches 100.

Referring to FIG. 44, the adaptation portion 2200 fits with the second fitting portion 1212, and the connecting member 213 is connected to the two workbenches 100 at the connecting position of the side walls 120 of the two workbenches 100.

In particular, a flexible connecting member 213 is configured as a flat and elongated shape. A material of the flexible connecting member 213 can be plastic. In other embodiments, the flexible connecting member 213 can be selected as required, which is not limited herein.

For example, the adaptation portion 2200 of the flexible connecting member 213 is configured as a through hole. The through hole of two ends of the connecting member 213 can be sleeved on a connecting protrusion 12121 of the workbench 100.

Furthermore, a shape and a size of a part of the connecting member 213 located between two adaptation portions 2200 is same as that of the first adaptation groove 12122 and can be same as that of the second adaptation groove 12123. In other words, the connecting member 213 can be snapped in the first adaptation groove 12122 or the second adaptation groove 12123 and does not protrude out from the side wall 120 of the workbench 100.

In particular, when only one adaptation portion 2200 of the connecting member 213 is connected to the connecting protrusion 12121, the connecting member 213 can penetrate through and rotate in the first adaptation groove 12122 or the second adaptation groove 12123.

For example, on a workbench 100, one adaptation portion 2200 can be detachably connected to the second fitting portion 1212, such that the connecting member 213 is snapped on the second adaptation groove 12123 along the vertical direction, a surface of the connecting member 213 does not protrude out from the side wall 120, and another adaptation portion 2200 is configured to be fixed or connected to the tools and the objects.

Referring to FIGS. 44 and 45, the present disclosure provides a workbench module 2000. The workbench module 2000 includes a fitted member 200 and at least two workbenches 100. Adjacent two workbenches 100 can be connected by the fitted member 200, thereby improving a usable area of the operation surface 104, facilitating several operators to operate, and improving an efficiency of processing and assembling the product.

For example, one adaptation portion 2200 of the connecting member 213 of the fitted member 200 is detachably connected to a second fitting portion 1212 of a first workbench 100, the other one of the adaptation portion 2200 of the connecting member 213 of the fitted member 200 is detachably connected to another second fitting portion 1212 of a second workbench 100, such that the connecting member 213 is connected to the two workbenches 100 along the horizontal direction.

Furthermore, when the connecting member 213 is connected to two workbenches 100, the connecting member 213 is snapped in the first adaptation groove 12122 of the two workbenches 100, such that a surface of the connecting member 213 does not protrude out from the side wall 120 of two workbenches 100. In order to improve firmness of connection between the two workbenches 100, two side walls 120 of the workbench 100 opposite to each other can be both provided with a second adaptation groove 12123. When the connecting member 213 is not configured to connect two workbenches 100, the connecting member 213 can be hanged on the connecting protrusion 12121 by one of the through holes, detached from the first adaptation groove 12122 and then be snapped in the second adaptation groove 12123 by rotating.

In the present embodiment, the two workbenches 100 can be connected by one connecting member 213. In other embodiments, a plurality of workbenches 100 can be connected by a plurality of connecting members 213, and arrangement of several workbenches 100 can be set as required, which is not limited herein.

In some embodiments, the adaptation portion 2200 fits with the first fitting portion 1211 or the third fitting portion 1213. The connecting member 213 can connect the two workbenches 100 at the connection position between the operation surfaces 104 of the two workbenches 100. For example, referring to FIGS. 54 to 56, the connecting member 213 is a rigid member with a certain degree of hardness. A material of the connecting member 213 can be plastic, in other embodiments, a material of the rigid connecting member 213 can be selected as required, which is not limited herein.

For example, referring to FIGS. 54 to 56, two ends of the rigid connecting member 213 are provided with an adaptation portion 2200, respectively. The fitting member 1201 of one workbench 100 of the workbench module 2000 fits with one of two adaptation portions 2200 of the connecting member 213 and the fitting member 1201 of the other one of the workbench 100 of the workbench module 2000 fits with the other one of the two adaptation portions 2200 of the connecting member 213, thereby realizing a connection between the two workbenches 100, improving the usable area of the operation surface 104, facilitating several operators to operating, and improving an efficiency of processing and assembling the product.

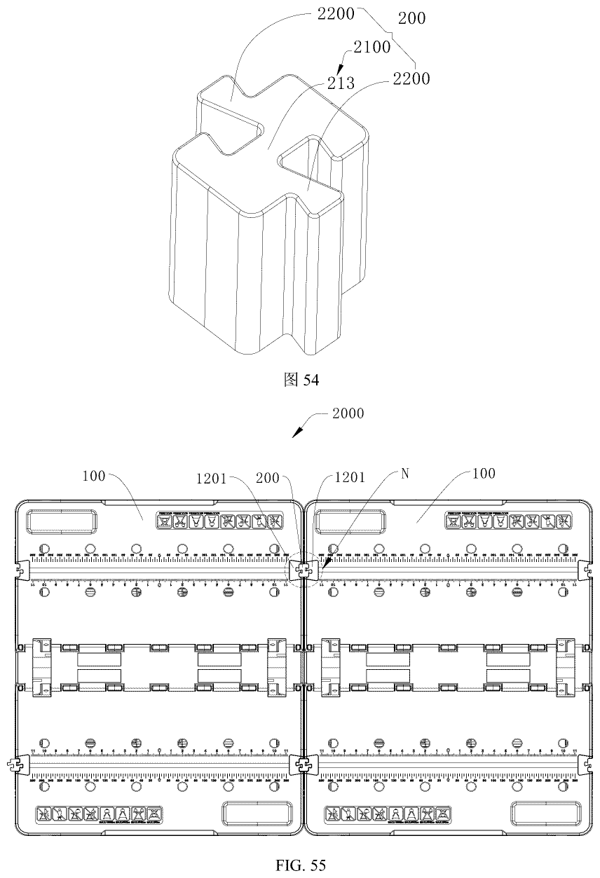

In particular, referring to FIG. 55, the two adaptation portions 2200 of the connecting member 213 are two snapping blocks connected backwards, the two snapping blocks fit with the fitting member 1201, two snapping blocks are snapped on the fitting member 1201 of the two workbenches 100, respectively, such that the two workbenches 100 are connected to each other.

In other embodiments, a plurality of workbenches 100 can be connected by a plurality of connecting members 213, and the arrangement of the plurality of workbenches 100 can be set as required, which is not limited herein.

In some embodiments, referring to FIGS. 41 and 42, the two adaptation portions 2200 of two ends of the connecting member 213 can be detachably mounted on the two fitting portions 1201 close to each other after the operating portion 10 of the workbench 100 being folded.

Referring to FIGS. 41 and 42, for example, two fitting portions 1201 are symmetrically disposed on two ends of the side wall 120 of the workbench 100, the workbench 100 can be folded to enable the two fitting portions 1201 to move towards each other. The connecting member 213 can be provided with the two adaptation portions 2200, and the two adaptation portions 2200 are detachably mounted on the two fitting portions 1201 of the workbench 100, respectively.

By such arrangement, it is conducive to accommodating the workbench 100 after being folded, thereby improving space utilization. The connecting member 213 can fix a folded workbench 100 by the two fitting portion 1201, thereby preventing a folded and accommodated operation surface 104 from opening, which is conducive to placing the accommodated workbench 100.

Referring to FIGS. 41 and 42, for example, in one embodiment, the adaptation portions 2200 fits with the second fitting portion 1213, when the operation surface 104 fully opens, the overall side wall 120 extends along the horizontal direction, two fitting portions 1201 are located on a left end and a right end of the side wall 120, respectively. The fitting member 1201 is symmetrically provided on a middle axis of the operation surface 104. Two first adaptation grooves 12122 extend backward along the horizontal direction, and two second adaptation grooves 12123 extend downward along the vertical direction. After the operation surface 104 being folded along an axis thereof, two fitting portions 1201 move towards each other, such that two second adaptation grooves 12123 extend along the horizontal direction relative to each other. One adaptation portion 2200 of the connecting member 213 is mounted on the connecting protrusion 12121 of one fitting portion 1201, the other adaptation portion 2200 is mounted on the connecting protrusion 12121 of the other one of the fitting member 1201, such that the connecting member 213 is located between two adaptation portions 12123, and the connecting member 213 is configured to fix the folded operation surface 104 and conducive to accommodating the workbench 100.

Furthermore, in one embodiment, referring to FIGS. 41 and 42, in order to facilitate accommodating the folded workbench 100, the operating portion 10 can form a spacing 140 after folding in middle. After the connecting member 213 being fixed and folded, the operating portion 10 can keep the spacing 140 unchanged, the spacing 140 can provide a certain give-way space, which is conducive to hanging the workbench 100 for accommodation.

For example, when the hook 211 is mounted on an external stacking box 310, the hook portion 2112 of the hook 211 can enter into the spacing 140, such that the overall folded workbench 100 can hang on the hook 211 of the stacking box 310. The workbench 100 can move with the stacking box 310. When the hook 211 is disposed on a wall, the second hook portion 2112 of the hook 211 can enter into the spacing 140, the folded workbench 100 fixed by the connecting member 213 can hanged on the wall, which is conducive to storing and fetching the workbench 100.

Furthermore, in the related art, the workbench is merely defined an operation surface of the operating portion away from the supporting portion as a work surface to place the objects or fix the fixture, such that the work surface of the operating portion is fixed and single, and has few applications.

Based on above description, the present disclosure further provides some embodiments, referring to FIGS. 57 to 63, the inventive concept and most of the structures of the workbench 100 of the workbench module 2000 are substantially the same as that of the workbench 100 in above embodiments, the differences are as follows: the workbench 100 further has a first working state and a second working state, the workbench 10 further includes an auxiliary bearing surface 107, the operating portion 10 can be rotatably connected to the supporting structure 20, such that the workbench 10 can be switched between the first working state and the second working state by rotating relative to the supporting structure 20.

In particular, when the workbench 100 is at the first working state, the operation surface 104 of the operating portion 10 is defined as a work surface, and when the workbench 100 is at the second working state, the auxiliary bearing surface 107 is defined as the work surface.

When the workbench 100 is at the first working state, the operating portion 10 rotates to enable the operation surface 104 to be away from the ground and is defined as the work surface. When the workbench 100 is at the second working state, the operating portion 10 rotates to enable the auxiliary bearing surface 107 to be away from the ground and is defined as the work surface. The operation surface 104 and the auxiliary bearing surface 107 can be used independently, thereby enlarging use functions of the workbench 100. The workbench 100 can be switched between the first working state and the second working state by rotating the operating portion 10, and an operation is simple.

Alternatively, in one embodiment, referring to FIGS. 57 to 62, the operating portion 10 is in a plate shape, the operation surface 104 and the supporting structure 20 are located on two sides of the operating portion 10 away from each other. The auxiliary bearing surface 107 is configured as a side surface of the operating portion 10 and located between the operation surface 104 and the supporting structure 20. Therefore, a structure of the operating portion 10 is simple, and it is conducive to processing. The operating portion 10 rotates in a relatively small angle to realize that the workbench 100 can be switched between the first working state and the second working state.

For example, referring to FIGS. 57 to 62, the plate-shape operating portion 10 includes a top wall and a bottom wall away from each other, and a periphery side of the top wall and the bottom wall includes four side walls. In particular, the operation surface 104 is configured as a surface where the top wall of the plate-shape operating portion 10 is located, a back surface 105 of the operating portion 10 is defined as a surface of the bottom wall, and the auxiliary bearing surface 107 is configured as a side surface of the plate-shape operating portion 10 along circumference of the auxiliary bearing surface, i.e., one side wall of the four side walls.

Referring to FIGS. 57 to 62, in some embodiments, when the workbench 100 is at the accommodating state, the first supporting portion 201 and the second supporting portion 202 are stacked in order, a side of the first supporting portion 201 or a side of the second supporting portion 202 rotates relative to the operating portion 10, such that the operating portion 10 abuts against a side of the first supporting portion 201 or a side of the second supporting portion 202.

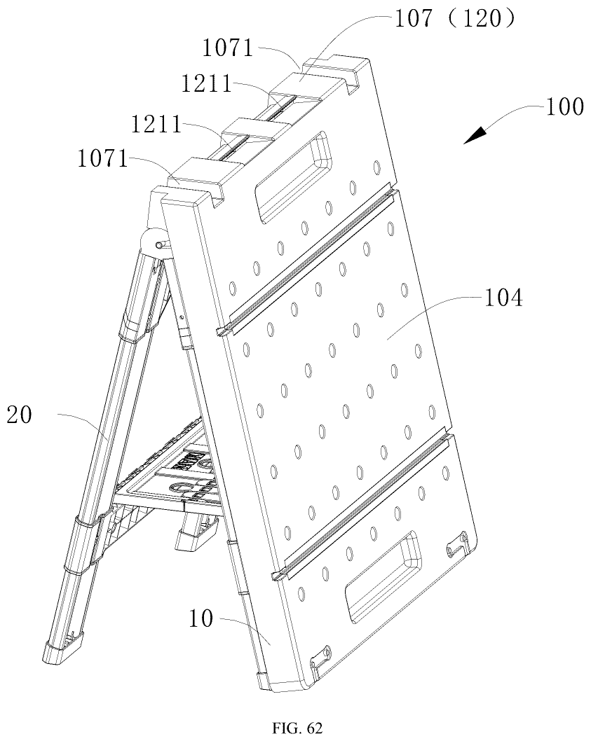

For example, referring to FIGS. 57 to 62, the first supporting portion 201 includes a third frame body 25. The second supporting portion 202 includes a fourth frame body 26. The third frame body 25 and the fourth frame body 26 are hinged on two opposite ends of the supporting structure 20, respectively. At least one of the third frame body 25 and the fourth frame body 26 is configured as a triangular support. In other words, referring to FIG. 59, it can be configured as the triangular support for only the third frame body 25. Alternatively, it can be configured as the triangular support for only the fourth frame body 26. Alternatively, referring to FIG. 62, it can be configured as the triangular support for the third frame body 25 and the fourth frame body 26. Since stability of the triangular structure is stronger, which is conducive to further improving a supporting effect of the supporting structure 20 for the operating portion 10 when the workbench 100 is at the first working state or the second working state.

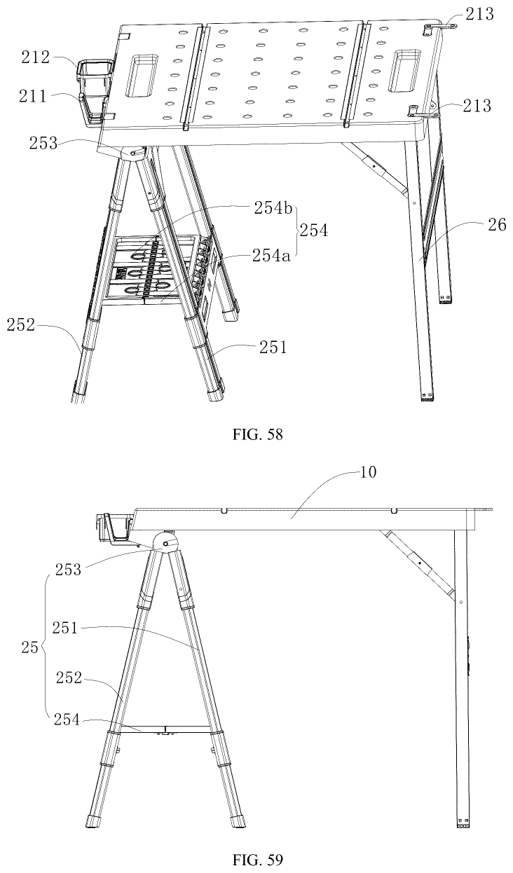

Referring to FIGS. 58, 59, 61 and 62, the triangular support includes a first supporting leg 251, a second supporting leg 252, a rotatable shaft 253 and a second fixing member 254. The first supporting leg 251 and the second supporting leg 252 are hinged on the operating portion by the rotatable shaft 253, respectively. The second supporting leg 254 is connected between the first supporting leg 251 and the second supporting leg 252. The second supporting leg 254, at least part of the first supporting leg 251, and at least part of the second supporting leg 252 forms a triangular structure.

Referring to FIGS. 59 and 62, for example, the third frame body 25 can be configured to include a first supporting leg 251, a second supporting leg 252, a rotatable shaft 253 and a second fixing member 254 to describe the first working state and the second working state of the workbench 100. The first supporting leg 251 is disposed towards the fourth frame body 26, and the auxiliary bearing surface 107 is disposed towards the second supporting leg 252.

Referring to FIG. 59, when the workbench 100 is at the first working state, the first supporting leg 251 and the second supporting leg 252 are obliquely disposed relative to the operating portion 10, respectively. The second fixing member 254, the first supporting leg 251, and the second supporting leg 252 surround to form the triangular structure. The fourth frame body 26 is perpendicular to the operating portion 10.

Referring to FIG. 62, when the workbench 100 is at the second working state, the first supporting leg 251 and the second supporting leg 252 are obliquely disposed relative to the operating portion 10, respectively. The second fixing member 254, the first supporting leg 251, and the second supporting leg 252 surround to form the triangular structure. The operating portion 10 rotates towards the third frame body 25 to limit the second supporting leg 252, and the auxiliary bearing surface 107 rotates to be disposed away from the third frame body 25. Therefore, the second supporting leg 252 abuts against the operating portion 10, thereby improving a contact area between the second supporting leg 252 and the operating portion 10, and facilitating the auxiliary bearing surface 107 to bearing the objects more stable.

In one embodiment, when the operating portion 100 is at the second working state, a side of the third frame body 25 towards the second supporting leg 252 rotates to be in contact with a lower part of the operating portion 10 and located between the second supporting leg 252 and the operating portion 10. In particular, in actual use, the third frame body 25 can be folded under the operating portion 10, and the operating portion 10 and the third frame body 25 rotates to limit a side of the second supporting leg 252.

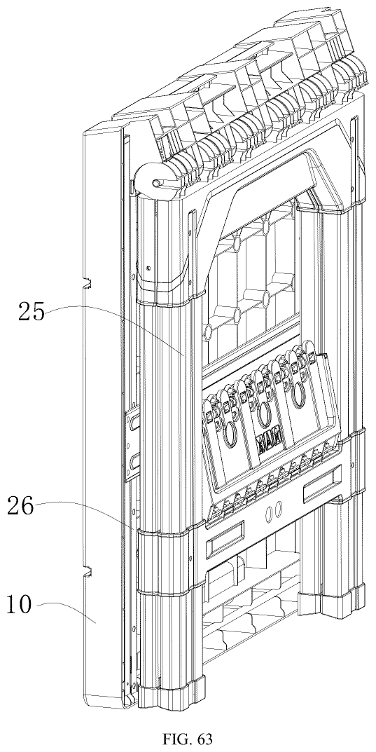

Referring to FIG. 63, when the operating portion 100 is at the accommodating state, the third frame body 25 and the fourth frame body 26 rotates towards the operating portion 10 to stack on the operating portion 10. Therefore, the supporting structure 20 can support the operating portion 10 more stably. Furthermore, the workbench 100 at the accommodating state occupies less space, which is conducive to storage.

In one embodiment, the third frame body 25 and the fourth frame body 26 can rotate towards each other to abut against a lower part of the operating portion 10. Alternatively, the third frame body 25 and the fourth frame body 26 can rotate away from each other to abut against the lower part of the operating portion 10.

In one embodiment, referring to FIGS. 58 and 62, the second fixing member 254 is in a plate shape and is capable of folding, such that, when the workbench 100 is at the accommodating state, the first supporting leg 251 and the second supporting leg 252 are in contact with each other. Therefore, when the first workbench 100 is at the first working state or the second working state, the second fixing member 254 can be used to place the objects. When the workbench 100 is at the accommodating state, the first supporting leg 251 is in contact with the second supporting leg 252 to occupy less space.

Furthermore, the second fixing member 254 includes a first fixing plate 254a and a second fixing member 254b hinged to each other, the first fixing plate 254a is connected to the first supporting leg 251, and the second fixing member 254b is connected to the second fixing member 252.

In particular, a structure of the second fixing member 254 can refer to a fitting structure between the first foldable plate 23 and the second foldable plate 24 in above embodiments, which is not limited herein. Alternatively, the second fixing member 254 can be configured as a hinge.

Referring to FIG. 62, the auxiliary bearing surface 107 is provided with a fixing position 1071, and the fixing position 1071 is configured to fix a block. Therefore, when the workbench 100 is at the second working state, the block is fixed on the fixing position 1071, and the workbench 100 can be used as the saw horse. In particular, the fixing position 107 is configured as a through groove.

Referring to FIG. 60, the workbench 100 further includes the fitting member 1201, the workbench module 2000 further includes at least one fitted member 200, and the fitted member 200 includes the tool body 2100 and the adaptation portion 2200. the fitting member 1201 is disposed on the operating portion 10 and can fit with the adaptation portion 2200 of the fitted member 200, thereby installing the fitted member 200 on the periphery side of the workbench 100. In particular, the fitting member 1201 includes but not limited to be configured as the first fitting portion 1211, the second fitting portion 1212 or the third fitting portion 1213. The tool body 2100 includes but not limited to be configured as the hook 211, the accommodating box 212, the fixture 210 or another workbench 100. A structure and fitting method of the fitting member 1201 and the fitted member 200 can be found in the above embodiments, which is not limited herein.

For example, the fitted member 200 can be snapped with the auxiliary bearing surface 107 or other side walls 120 of the operating portion 10.

Referring to FIG. 57, the operation surface 104 is provided with the second mounting hole 14 and the first accommodating groove 11, and the second mounting hole 14 and the first accommodating groove 11 are configured to fix the fixture 210, respectively, to clamp the external object 300.

In particular, the number of second mounting holes 14 is multiple, and a plurality of second mounting holes 14 are disposed in array. The number of first accommodating grooves 11 is multiple, and a plurality of first accommodating groove 11 are disposed in array.

The various technical features of the above embodiments can be combined in any way. In order to make the description concise, not all possible combinations of the various technical features in the above embodiments have been described. However, as long as there is no contradiction in the combination of these technical features, they should be considered within the scope of the specification.

One of ordinary skill in the art should recognize that the above embodiments are used only to illustrate the present disclosure and are not used to limit the present disclosure, and that appropriate variations and improvements to the above embodiments fall within the protection scope of the present disclosure so long as they are made without departing from the substantial spirit of the present disclosure.

1. A workbench comprising an operating portion configured for users to process an external object and a supporting structure configured to support the operating portion, wherein the operating portion comprises at least one fitting member, the at least one fitting member is located on a periphery side of the operating portion and configured to be detachably connected to a fitted member; the supporting structure comprises a first supporting portion and a second supporting portion connected to the operating portion; the workbench has an accommodating state, when the workbench is at the accommodating state, the first supporting portion and the second supporting portion are folded up or stacked in order;
wherein a part of the operating portion is capable of being in contact with a side of the first supporting portion, a part of the operating portion is capable of being in contact with a side of the second supporting portion; or the operating portion is capable of being in contact with a side of the first supporting portion; or the operating portion is capable of being in contact with a side of the second supporting portion.

2. The workbench of claim 1, wherein the at least one fitting member and the operating portion are an integral structure or a separated structure; and/or
a side wall of the operating portion is provided with a mounting notch, the at least one fitting member is detachably mounted on the mounting notch.

3. The workbench of claim 2, wherein the operating portion further comprises a bearing portion, the bearing portion is located on a side of the mounting notch towards a bottom wall of the operating portion, and the bearing portion is configured to limit the at least one fitting member.

4. The workbench of claim 1, wherein the at least one fitting member comprises a first fitting portion, and the first fitting portion comprises a snapping groove formed on a side of the operating portion.

5. The workbench of claim 4, wherein the operating portion comprises an operation surface and a back surface separated from each other, a side wall of the operating portion is formed between the operation surface of the operating portion and the back surface of the operating portion; and the snapping groove is provided with a first groove opening located on the operation surface of the operating portion.

6. The workbench of claim 5, wherein the snapping groove is provided with a second groove opening in communication with the first groove opening, the second groove opening is formed on the side wall of the operating portion, and a size H2 of the second groove opening along a depth direction of the snapping groove is less than a depth H1 of the snapping groove.

7. The workbench of claim 4, wherein at least part of the snapping groove penetrates through the operating portion along a vertical direction of the workbench.

8. The workbench of claim 7, wherein along the vertical direction of the workbench, the snapping groove comprises a first groove segment and a second groove segment in communication with each other, the second groove segment is formed on a bottom wall of the first groove segment, and the second groove segment penetrates through the operating portion.

9. The workbench of claim 4, wherein an inner sidewall of the snapping groove is provided with a plurality of limiting lock blocks protruding outwards, and the plurality of limiting lock blocks are arranged at intervals.

10. The workbench of claim 1, wherein the at least one fitting member comprises a second fitting portion, and the second fitting portion comprises a connecting protrusion disposed on and protruding out from a side wall or a top wall of the operating portion.

11. The workbench of claim 10, wherein the second fitting portion further comprises a first adaptation groove and a second adaptation groove in communication with each other, a depth direction of the first adaptation groove and a depth direction of the second adaptation groove are both parallel to a protruding direction of the connecting protrusion, a length direction of the first adaptation groove is perpendicular to a length direction of the second adaptation groove, and the connecting protrusion is located on a communication position between the first adaptation groove and the second adaptation groove.

12. The workbench of claim 1, wherein the at least one fitting member comprises a third fitting portion, the third fitting portion comprises a first connecting groove where a depth direction of the first connecting groove is perpendicular to a side wall of the operating portion, a size of a bottom wall of the first connecting groove along a width direction a of the first connecting groove is greater than that of a groove opening of the first connecting groove along the width direction a of the first connecting groove, the first connecting groove is provided with a top groove opening, and a side of the first connecting groove away from the top groove opening is provided with a barrier block.

13. The workbench of claim 12, wherein the third fitting portion further comprises a second connecting groove and a first protrusion, the first connecting groove is formed on a bottom wall of the second connecting groove, the first protrusion protrudes out from the bottom wall of the second connecting groove, the first protrusion comprises a connecting portion and a convex portion, the connecting portion is connected to the bottom wall of the second connecting groove, the convex portion is connected to a side of the connecting portion away from the bottom wall of the second connecting groove, and a size of the convex portion along the width direction a of the first connecting groove is greater than that of the connecting portion along the width direction a of the first connecting groove.

14. The workbench of claim 1, wherein the supporting portion is rotatably connected to the operating portion, the workbench further has a first working state and a second working state, the operating portion is capable of turning over relative to the supporting portion in order to switch between the first working state and the second working state; and
the operating portion comprises an operation surface and an auxiliary bearing surface, wherein when the workbench is at the first working state, the operation surface is defined as a work surface; and when the operating portion is at the second working state, the auxiliary bearing surface is defined as a work surface.

15. The workbench of claim 14, wherein the operating portion is in a plate shape, the operation surface and the supporting portion are located on two sides of the operating portion opposite to each other, and the auxiliary bearing surface is configured as a side surface of the operating portion and located between the operation surface and the supporting structure.

16. The workbench of claim 15, wherein the first supporting portion comprises a third frame body, the second supporting portion comprises a fourth frame body, the third frame body and the fourth frame body are hinged at two opposite ends of the operating portion; and at least one of the third frame body and the fourth frame body is configured as a triangular support.

17. The workbench of claim 16, wherein the triangular support comprises a first supporting leg, a second supporting leg, a rotatable shaft and a second fixing member; and
the first supporting leg and the second supporting leg are hinged on the operating portion by the rotatable shaft, respectively, the second fixing member is connected between the first supporting leg and the second supporting leg, and the second fixing member, at least part of the first supporting leg, and at least part of the second supporting leg are formed a triangle.

18. The workbench of claim 17, wherein the first supporting leg is disposed towards the fourth frame body, the auxiliary bearing surface is disposed towards the second supporting leg; when the operating portion is at the second working state, the operating portion rotates towards the third frame body until being limited by the first supporting leg, and the auxiliary bearing surface turns over until being separated from the third frame body; and/or
the second fixing member is in a plate shape and capable of being folded, such that, when the workbench is at the accommodating state, the first supporting leg and the second supporting leg are in contact with each other.

19. A workbench module comprising at least one workbench of the claim 1 and at least one fitted member, wherein the at least one fitted member comprises a tool body and at least one adaptation portion, the at least one adaptation portion is disposed on the tool body, the at least one adaptation portion fits with at least part of the at least one fitting member and is configured to detachably fit with the at least fitting member of the workbench.

20. The workbench module of claim 19, wherein the tool body is a hook, the hook comprises a fastening portion and a hook portion, the hook portion is connected to the fastening portion, the adaptation portion is connected to a side of the fastening portion away from the hook portion; or
the tool body is an accommodating box, the accommodating box is provided with a cavity, the adaptation portion is connected to an outer periphery wall of the accommodating box; or
the tool body is a fixture, the fixture comprises a rod, a movable fixture body and a fixed fixture body, the rod penetrates through the movable fixture body and the fixed fixture body, the adaptation portion is connected to a side of the fixed fixture body away from the movable fixture body; or
the tool body is another workbench, the adaptation portion protruding out from a side of the workbench is disposed on the side of the workbench; or
the fitted member comprises two adaptation portions, the tool body is a connecting member with a preset length; the two adaptation portions are disposed on two ends of the connecting member opposite to each other, the two adaptation portions are detachably connected to the fitting member of two workbenches or detachably mounted on adjacent two fitting members of one workbench after being folded.
